(19) United States
(12) Patent Application Publication
(10) Pub. No.: US 2022/0268795 A1
(43) Pub. Date: Aug. 25, 2022

(54) AUTOMATED LIBRARY GENERATOR

(71) Applicant: 10x Genomics, Inc., Pleasanton, CA (US)

(72) Inventors: Pratomo Putra ALIMSIJAH, Palo Alto, CA (US); Bryan C. STEWART, Pleasanton, CA (US); Alexander Post KINDWALL, Pleasanton, CA (US); Andrew PRICE, Pleasanton, CA (US); John Richard CHEVILLET, Pleasanton, CA (US)

(21) Appl. No.: 17/742,793

(22) Filed: May 12, 2022

Related U.S. Application Data
(63) Continuation of application No. PCT/US2020/061116, filed on Nov. 18, 2020.
Application No. PCT/US2020/061116 is a continuation-in-part of application No. 16/835,090, filed on Mar. 30, 2020.
(60) Provisional application No. 63/045,754, filed on Jun. 29, 2020.
(60) Provisional application No. 63/017,491, filed on Apr. 29, 2020.
(60) Provisional application No. 63/016,834, filed on Apr. 28, 2020.
(60) Provisional application No. 63/016,838, filed on Apr. 28, 2020.
(60) Provisional application No. 62/980,768, filed on Feb. 24, 2020.
(60) Provisional application No. 62/953,050, filed on Dec. 23, 2019.
(60) Provisional application No. 62/980,768, filed on Feb. 24, 2020.
(60) Provisional application No. 62/980,771, filed on Feb. 24, 2020.
(60) Provisional application No. 62/980,945, filed on Feb. 24, 2020.
(60) Provisional application No. 62/953,050, filed on Dec. 23, 2019.
(60) Provisional application No. 62/943,182, filed on Dec. 3, 2019.
(60) Provisional application No. 62/938,485, filed on Nov. 21, 2019.

(51) Int. Cl. G01N 35/00; G01N 35/10

(52) U.S. Cl. CPC G01N 35/00693; G01N 35/00732; G01N 35/0098; G01N 35/1011; G01N 35/1074; G01N 2035/00752; G01N 2035/00445; G01N 2035/00801; G01N 2035/103

(57) ABSTRACT

A calibration device is disclosed. The device comprises an array of teaching pendants. The device comprises a translation actuator configured to translate the array of teaching pendants to a set of x and y positions, wherein the x and y positions are measured in a plane substantially parallel to a floor of an instrument deck. The device comprises a plurality of height actuators configured to move each of the teaching pendants in a direction substantially perpendicular to the plane. One or more of the teaching pendants contact one or more teaching objects of an array of teaching objects above the instrument deck as a result of a position of the array of teaching pendants.

### BACKGROUND OF THE INVENTION

Ribonucleic acid (RNA) is a polymeric molecule essential in various biological roles in the coding, decoding, regulation, and expression of genes. RNA-sequencing (RNA-Seq) uses next-generation sequencing (NGS) to reveal the presence and quantity of RNA in a biological sample at a given moment. RNA-Seq analyzes the transcriptome of gene expression patterns encoded within the RNA.

Traditional RNA-Seq techniques analyze the RNA of an entire population of cells, but only yield a bulk average of the measurement instead of representing each individual cell's transcriptome. By analyzing the transcriptome of a single cell at a time, the heterogeneity of a sample is captured and resolved to the fundamental unit of living organisms—the cell. Single cell transcriptomics examines the gene expression level of individual cells in a given population by simultaneously measuring the messenger RNA (mRNA) concentration of hundreds to thousands of genes.

Automated library generators have been developed integrating various components to achieve RNA sequencing. There is a need to provide an efficient and reliable automated library generator. One important component is a movable pipetting device. There is a need to improve the calibration of the device such that the calibration is reliable and efficient. One important aspect is consumable tracking and error detection. There is a need to provide a consumable tracking and error detection device such that consumables are loaded into the system correctly. Another important component is a magnetic separator which interacts with a fluid in a vial. There is a need to improve the interaction in a way that allows fluid to be used efficiently and to provide consistent results.

### BRIEF DESCRIPTION OF THE DRAWINGS

Various embodiments of the invention are disclosed in the following detailed description and the accompanying drawings.

FIG. 1 illustrates a front view of one embodiment of an automated library generator 100.

FIG. 2 illustrates another view of one embodiment of an automated library generator 200.

FIG. 3 illustrates yet another view of one embodiment of an automated library generator 300.

FIG. 4 illustrates an embodiment of a multi-channel pipetting head 402.

FIG. 5 illustrates an embodiment of a teaching pendant 501.

FIG. 6 illustrates an embodiment of an array of teaching pendants 601 coupled to a multi-channel pipetting head 602 of a liquid handling gantry 638.

FIG. 7A illustrates a top view of an embodiment of a magnetic separator plate 702.

FIG. 7B illustrates a cross sectional view of the magnetic separator plate 702.

FIG. 7C illustrates another view of the magnetic separator plate 702.

FIG. 8 illustrates an exemplary consumable 802 that may be loaded onto the magnetic separator plate 214 or magnetic separator plate 702 where magnetic bead-based cleanup may be performed.

FIG. 9A illustrates a top view of a magnetic separator plate adapter 902.

FIG. 9B illustrates a cross sectional view of the magnetic separator plate adapter 902.

FIG. 9C illustrates a bottom view of the magnetic separator plate adapter 902.

FIG. 9D illustrates another view of the top surface of the magnetic separator plate adapter 902.

FIG. 9E illustrates another view of the bottom surface of the magnetic separator plate adapter 902.

FIG. 10A illustrates a cross sectional view of a teaching object 908.

FIG. 10B illustrates a top view of teaching object 908.

FIG. 11A illustrates a top view of the magnetic separator plate adapter 902 being loaded onto the magnetic separator plate 702.

FIG. 11B illustrates a cross sectional view of the magnetic separator plate adapter 902 being loaded onto the magnetic separator plate 702.

FIG. 11C illustrates another cross sectional view of the magnetic separator plate adapter 902 being loaded onto the magnetic separator plate 702.

FIG. 11D illustrates a portion of a magnified cross sectional view of the magnetic separator plate adapter 902 being loaded onto the magnetic separator plate 702.

FIG. 12A illustrates a view of the magnetic separator plate adapter 902 about to be loaded onto the magnetic separator plate 702 and the 96-tube PCR plate 802 about to be loaded onto the magnetic separator plate adapter 902.

FIG. 12B illustrates another view of the magnetic separator plate adapter 902 being loaded onto the magnetic separator plate 702 and the 96-tube PCR plate 802 being loaded onto the magnetic separator plate adapter 902.

FIG. 13 illustrates another embodiment of a magnetic separator plate adapter 1302.

FIG. 14 illustrates another embodiment of a module 1402.

FIG. 15 illustrates another embodiment of a module 1502.

FIG. 16 illustrates another embodiment of a module 1602.

FIG. 17 illustrates another embodiment of a module 1702.

FIG. 18 illustrates an embodiment of a module 1802 with features, surfaces, or components that may be utilized as teaching objects.

FIG. 19 illustrates another embodiment of a module 1902 with features, surfaces, or components that may be utilized as teaching objects.

FIG. 20 illustrates an embodiment of a process 2000 for automatically calibrating the positioning of a liquid handling gantry with a pipetting head.

FIG. 21 illustrates an embodiment of a teaching datum detection process 2100.

FIG. 22 illustrates an example of determining the left and right edges of a teaching datum 908 in channel #1.

FIG. 23 illustrates an embodiment of a well detection process 2300.

FIG. 24 illustrates one embodiment of a consumable tracking and error detection system 2400 for automated library generator 200.

FIG. 25 illustrates a plurality of strip tubes 2502 that may be loaded onto the cold plate reagent module 220.

FIG. 26 illustrates that four strip tubes 2502 are loaded onto the cold plate reagent module 220.

FIG. 27 illustrates one embodiment of one plate of an automated cell library and gel bead kit for the automated library generator 200.

FIG. 28 illustrates a plurality of plates of an automated cell library and gel bead kit for the automated library generator 200.

FIG. 29 illustrates that barcodes on the deck module and the barcodes on the consumables may be read by the barcode readers through a plurality of mirrors.

FIG. 30 illustrates an embodiment of a process 3000 for tracking consumables and detecting errors in loading the consumables in an automated library generator 200.

FIG. 31 illustrates another embodiment in which barcodes are placed on a deck module 3101 and the consumables 3104A and 3104B that are loaded onto the module.

FIG. 32A illustrates a view of one embodiment of a thermal cycler 3200.

FIG. 32B illustrates a view of one embodiment of a thermal cycler 3200.

FIG. 33 illustrates a front view of the automated library generator 3300.

FIG. 34 illustrates a top view of the automated library generator 3300.

FIG. 35 illustrates a view showing a portion of the left vertical side frame 3320B, the bottom base frame 3320D, and an integrated communication and power base compartment 3508 of automated library generator 3300.

FIG. 36 illustrates yet another view of automated library generator 3300.

FIG. 37 illustrates another exemplary configuration of an automated library generator 3700 in which airflow is created to eliminate hot spots within the system.

FIG. 38 illustrates another embodiment of an automated library generator 3800 with a HEPA filter hood 3802,

FIG. 39 illustrates a disposable PCR lid 3900.

FIG. 40 illustrates a core gripper 4002 lifting a piece of labware 4004 up and moving the piece of labware 4004 to another position within the deck.

FIG. 41 illustrates a plurality of disposable tips that may be attached to the pipetting head.

FIG. 42 illustrates that with the added divider 4202, one side of the waste disposal bin is used for storing the tips and the other side of the waste disposal bin is used for storing the lids.

FIG. 43A illustrates a view of an automated library generator 4300 that includes an integrated communication and power base compartment 4310.

FIG. 43B illustrates a view of the integrated communication and power base compartment 4310.

FIG. 43C illustrates a view of the integrated communication and power base compartment 4310.

FIG. 44 illustrates an exemplary schematic diagram 4400 showing the connections of the integrated communication and power base compartment with other components of the automatic library generator.

FIG. 45A illustrates a top view of the 96-tube PCR plate 802 being loaded onto the magnetic separator plate 702.

FIG. 45B illustrates a cross sectional view of the 96-tube PCR plate 802 being loaded onto the magnetic separator plate 702.

FIG. 45C illustrates a portion of a magnified cross-sectional view of the 96-tube PCR plate 802 being loaded onto the magnetic separator plate 702.

FIG. 46A illustrates a top view of the magnetic separator plate adapter 902 being loaded onto the magnetic separator plate 702, and the 96-tube PCR plate 802 being loaded onto the magnetic separator plate adapter 902.

FIG. 46B illustrates a cross-sectional view of the magnetic separator plate adapter 902 being loaded onto the magnetic separator plate 702, and the 96-tube PCR plate 802 being loaded onto the magnetic separator plate adapter 902.

FIG. 46C illustrates another cross-sectional view of the magnetic separator plate adapter 902 being loaded onto the magnetic separator plate 702, and the 96-tube PCR plate 802 being loaded onto the magnetic separator plate adapter 902.

FIG. 46D illustrates a portion of a magnified cross-sectional view of the magnetic separator plate adapter 902 being loaded onto the magnetic separator plate 702, and the 96-tube PCR plate 802 being loaded onto the magnetic separator plate adapter 902.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Preparing consistent gene expression libraries is labor intensive and requires extensive hands-on (i.e., manual) time. It would be beneficial if this could be automated, freeing lab personnel to perform other tasks.

Automated techniques for the preparation of gene expression libraries are disclosed in the present application. The techniques provided herein allow for the maximization of consistency in the libraries prepared and productivity of the personnel. The techniques improve quality and performance by 1) decreasing technical variability and generating reproducible results; 2) running pre-validated protocols for single cell assays; and 3) providing a robust workflow and ready-to-use solution. The techniques save time and resources by 1) reducing hands-on time in the lab; 2) eliminating the need for dedicated resources; and 3) requiring no specialized expertise. The techniques are integrated and validated; single cell partitioning, barcoding, and library preparation are integrated together in one optimized instrument. As a result, less customization and optimization are needed, thereby improving productivity.

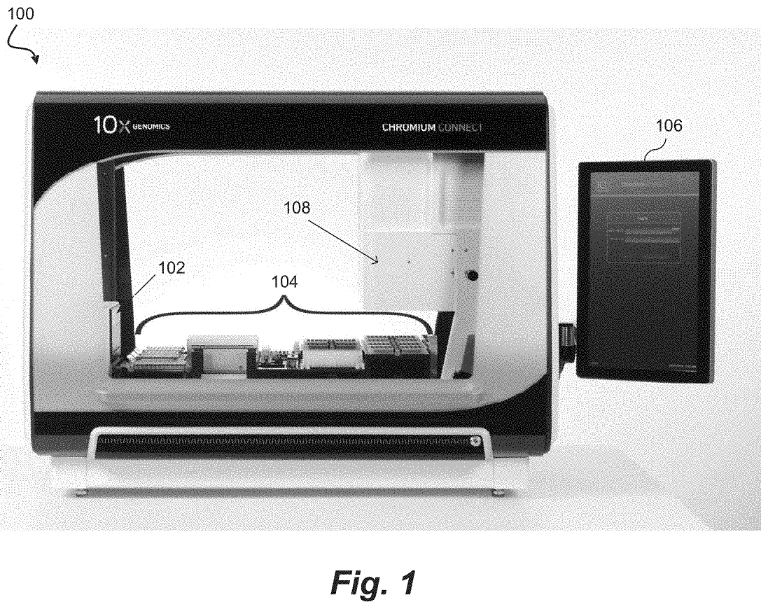

FIG. 1 illustrates a front view of one embodiment of an automated library generator 100. The system includes an automated controller 102 on deck for single cell partitioning and barcoding. Reagents and consumables may be loaded onto the instrument deck area 104 at the beginning of each run. Operations may be guided through an easy-to-use touchscreen computer 106 with Internet connectivity. System 100 includes a liquid handling gantry 108 that may perform pipetting steps throughout the entire workflow. System 100 further includes one or more barcode scanners that enable lot and reagent tracking for reagents and consumables.

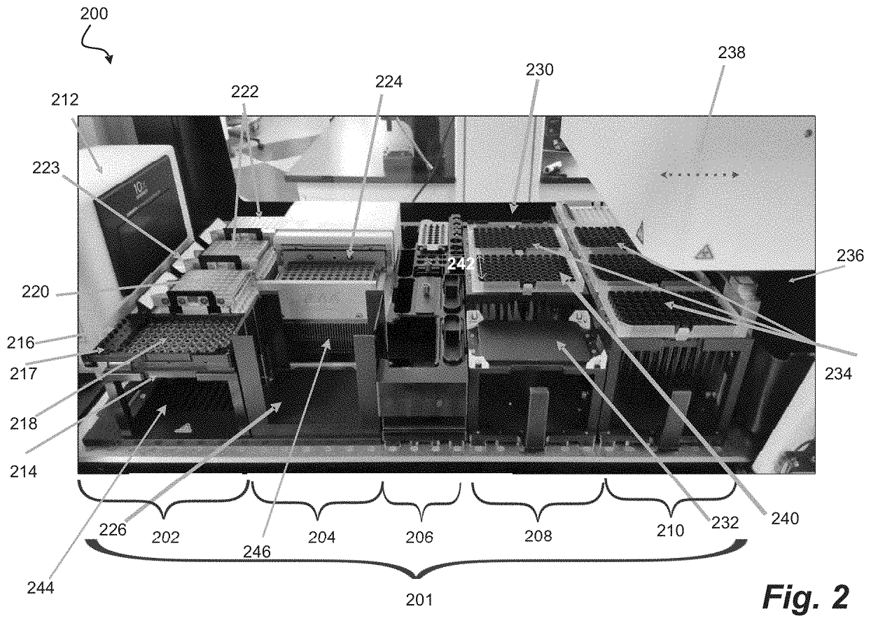

FIG. 2 illustrates another view of one embodiment of an automated library generator 200. Automated library generator 200 includes five carriers (202, 204, 206, 208, and 210) on the deck 201. Some of the carriers are stationary and some of the carriers may slide in and out for loading and unloading items. Each of the carriers may be loaded with different types of labware, deck modules, deck objects, and consumables, such as a magnetic separator plate, a thermal cycler block, tips, reagent reservoirs, plates (e.g., polymerase chain reaction (PCR) plates and deep well plates), tubes, and the like. The terms labware, deck modules, and deck objects may be used interchangeably in the present application.

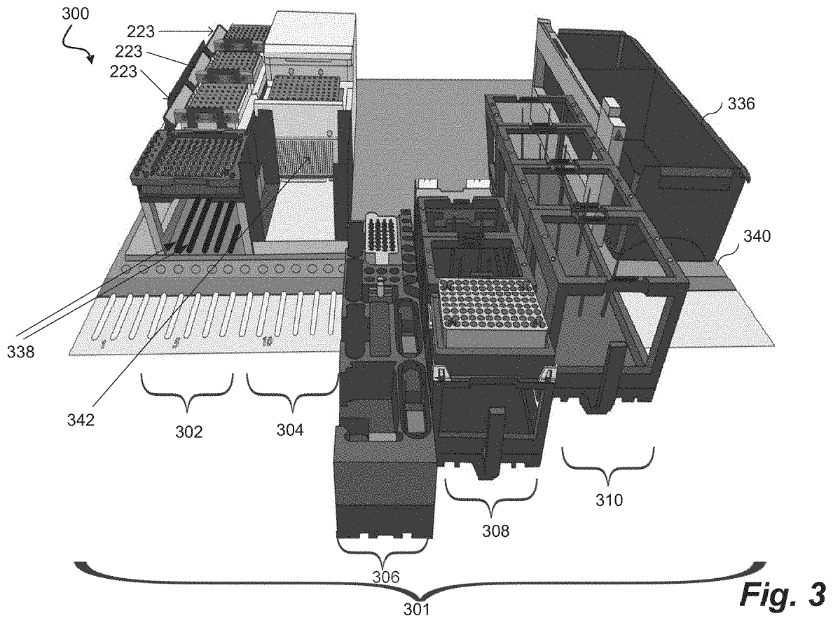

FIG. 3 illustrates yet another view of one embodiment of an automated library generator 300. Automated library generator 300 includes five carriers (302, 304, 306, 308, and 310) and a disposal bin 336 above a deck floor 340 of a deck 301.

As shown in FIG. 2, an automated controller 212 for single cell partitioning and barcoding is located adjacent to the leftmost carrier 202. The leftmost carrier 202 includes a magnetic separator plate 214. An array of magnets 218 is located above magnetic separator plate 214. Arrays of wells, tips, or tubes may be placed above the array of magnets 218. In some embodiments, a magnetic separator plate adapter 217 may be mounted on top of the magnetic separator plate 214 to keep the array of tips/tubes stable and sitting at the exact locations. The magnetic separator plate adapter 217 may rest above the magnetic separator plate 214 and the array of magnets 218. The magnetic separator plate adapter 217 may be formed of plastic and include skirts. Magnetic separator plate adapter 217 may include a plurality of calibration posts 216. Carrier 202 may further receive a cold plate reagent module 220 and other reagent modules 222.

In some embodiments, automated library generator 200 may include a barcode reading system. A barcode reader is used to scan reagents and consumables. The barcode reading system enables experiment tracking and prevents reagent mix-ups. A barcode reader (not shown in FIG. 2) may be placed above the five carriers (202, 204, 206, 208, and 210) on deck 201. The barcode reader may be used to read the slots for holding the tips/tubes and the tips/tubes that go into the slots at different locations. The barcode reading system may include software logic to make sure that the right tubes (with reagents) are put at the right slots. The barcode reading system may also detect that the tubes are missing such that the system may inform the user about these errors. The system may check for color matching, lot numbers, and expiration dates. As shown in FIG. 2, automated library generator 200 may include a plurality of mirrors 223 to allow the barcode reader to read sideways and at more locations. In some embodiments, stickers with barcodes on the slots are covered by the tips/tubes if they are placed there. If the barcode reader reads the barcodes on the slots, then the slots are determined as being empty. If the barcode reader reads the barcodes on the tips/tubes, then the system may match the two barcodes.

Carrier 204 (the second carrier from the left) includes an on-deck thermal cycler 224 (ODTC). A thermal cycler may be used to amplify segments of Deoxyribonucleic acid (DNA) via the polymerase chain reaction (PCR). Thermal cyclers may also be used to facilitate other temperature-sensitive reactions. In some embodiments, a thermal cycler has a thermal block with holes where tubes holding reaction mixtures may be inserted. The thermal cycler then raises and lowers the temperature of the block in discrete, pre-programmed steps. Carrier 204 further includes a rack 226 for storing disposable ODTC lids.

Carrier 206 (the third carrier from the left) includes carrier spaces for receiving, storing, or loading tube strips, chips, gel beads, core or lifting paddles, ethanol reservoirs, primer, glycerol, and the like. Carrier 208 (the fourth carrier from the left) includes a sample index plate holder 230. The carrier further includes a unit 232 for formulations and bead cleanups. Carrier 208 and carrier 210 (the fifth carrier from the left) may receive different consumables, such as pipette tips 234.

Automated library generator 200 may further include a waste disposal bin 236 that is adjacent to carrier 210. In some embodiments, a divider may be added to the waste disposal bin for separating the recycled tips and lids. With the added divider, one side of the disposal bin is used for storing the tips and the other side of the disposal bin is used for storing the lids. A gantry 238 may be programmed to drop the tips and the lids on different sides of the disposal bin. This prevents the lids from stacking up and toppling over, causing the system to malfunction. This allows the recycling of the lids while preventing contamination.

The liquid handling gantry 238 in automated library generator 200 may perform automated pipetting steps throughout the entire workflow. Liquid handling gantry 238 is a movable liquid-handling pipetting device with precision positioning.

A traditional manual pipette is a laboratory tool commonly used in chemistry, biology, and medicine to transport a measured volume of liquid. A pipette can be used to aspirate (or draw up) a liquid into a pipette tip and dispense the liquid. In manual pipetting, a piston is moved by a thumb using an operation knob. Accuracy and precision of pipetting depend on the expertise of the human operator.

Automated pipetting has many advantages over manual pipetting. Automated pipetting enhances the throughput and the reproducibility of laboratory experiments. Automated pipetting takes the manual labor out of repeated pipetting, thereby shortening manual hands-on time. Reducing manual hands-on time frees up time and effort for other tasks, thereby greatly improving throughput. Furthermore, automated pipetting significantly reduces errors from manual pipetting, thereby enhancing reproducibility.

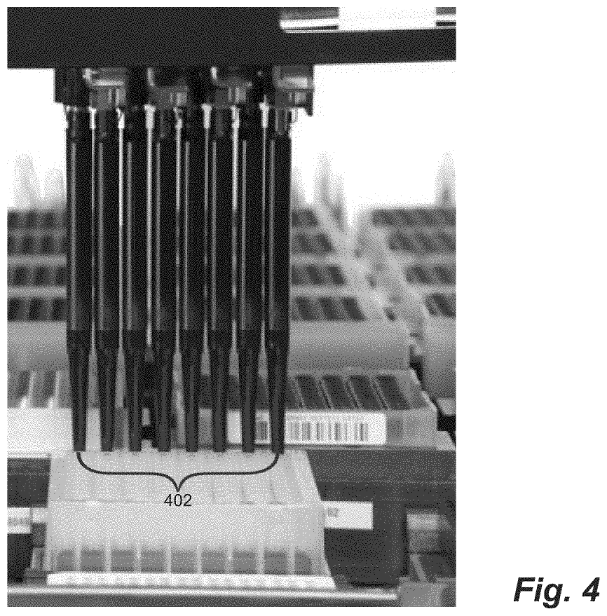

The liquid handling gantry 238 in automated library generator 200 includes a pipetting head, which is the mechanical component for liquid transfer. In some embodiments, the pipetting head is a multi-channel pipetting head for increased throughput. FIG. 4 illustrates an embodiment of a multi-channel pipetting head 402. In some embodiments, the pipetting head may be an 8-channel pipetting head coupled to a pump system such that for each channel, a volume of liquid may be aspirated from a source container by creating suction and then dispensed into a destination container (e.g., a tube or a well). A disposable tip may be attached to each of the eight channels of the pipetting head, such that the liquid is not in direct contact with the pipetting head, preventing cross contamination.

The liquid handling gantry 238 with the pipetting head may be programmed to move within a working area where liquid aspirating and dispensing take place. The working area may be the deck area 201 including the five carriers (202, 204, 206, 208, and 210) that may be loaded with different types of labware, modules, deck objects, or consumables, such as reagent reservoirs, plates (e.g., polymerase chain reaction (PCR) plates and deep well plates), tubes, and the like. For example, the pipetting head may be moved to the position of the reagent module 240 to dispense liquid into a row 242 of eight wells of the reagent module 240. The position of the reagent module 240 and the position of the row of wells may each be specified by a set of offset distances in the x, y, and z axes from one or more reference points within deck area 201. In some embodiments, the position of a certain module or labware may be recorded by library generator 200 as a first set of offset values (in x, y, and z) from a reference point within deck area 201, and the position of a row of wells within the module or labware may further be recorded by the system as another set of offset values from the position of the module or labware. In some embodiments, different positions within the working area are recorded by library generator 200 as different sets of offset values from a single reference point within deck area 201.

In order to place the pipetting head into the appropriate source and destination containers, the liquid handling gantry 238 with the pipetting head may be moved by one or more actuators to different x and y positions in a plane substantially parallel to the floor of deck 201. In addition, the pipetting head may be moved by one or more actuators in a direction substantially perpendicular to the plane, such that the pipetting head and the tips attached to the pipetting head may be inserted into or withdrawn from the source and destination containers.

Accuracy and precision in positioning the pipetting head are important because the pipetting tips often need to be lowered to the center of and close to the bottom of the containers in order to accurately transfer very small volumes of liquid; otherwise, the results of an experiment may be affected. Therefore, calibration of the positioning of the liquid handling gantry 238 with the pipetting head should be performed periodically to maintain a high level of accuracy and precision. However, manual calibration of the positioning of the liquid handling gantry 238 with the pipetting head depends on the expertise of the human operator and may be prone to errors. Therefore, improved techniques of automatically calibrating the positioning of the liquid handling gantry 238 with the pipetting head would be desirable.

In the present application, a calibration device is disclosed. The calibration device includes an array of teaching pendants. A translation actuator is configured to translate the array to a set of x and y positions, wherein the x and y positions are measured in a plane substantially parallel to a floor of an instrument deck. A plurality of height actuators is configured to move each of the teaching pendants in a direction substantially perpendicular to the plane, wherein one or more of the teaching pendants contact one or more teaching objects of an array of teaching objects on or above the instrument deck as a result of the position of the array of teaching pendants.

In the present application, a method of calibrating a device is disclosed. An array of teaching pendants is translated to a region where an array of teaching objects is located. A plurality of translation positions at which at least one pendant in the array of teaching pendants engages a teaching object in the array of teaching objects is detected. An adjustment offset based on the detected translation positions is determined.

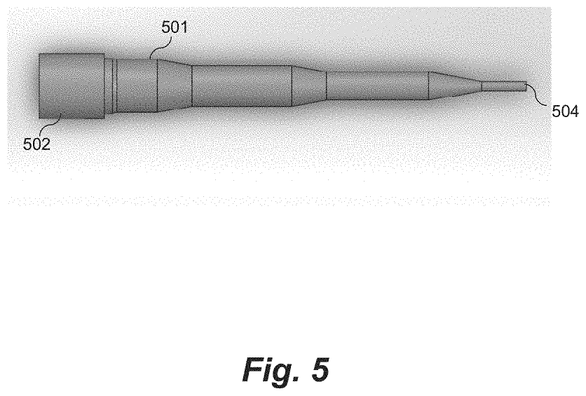

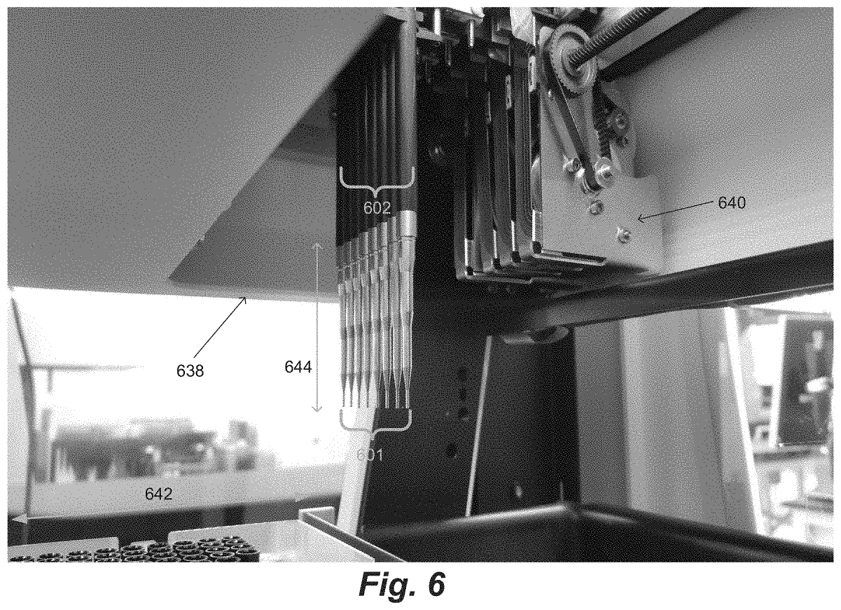

FIG. 5 illustrates an embodiment of a teaching pendant 501. FIG. 6 illustrates an embodiment of an array of teaching pendants 601 coupled to a multi-channel pipetting head 602 of a liquid handling gantry 638.

As shown in FIG. 5, a teaching pendant 501 may include a portion 502 that may be coupled to a pipetting head of a liquid handling gantry. The teaching pendant 501 may taper to a pointed, round, or flat tip or end 504 for contacting and detecting targeted teaching objects. In some embodiments, teaching pendant 501 may be formed with a metal.

As shown in FIG. 6, a linear array of teaching pendants 601 is coupled to an 8-channel pipetting head 602 of liquid handling gantry 638. One or more actuators 640 may be used to move the x, y, and z positions of each of the teaching pendants 601. A translation actuator is configured to translate the array of teaching pendants 601 to different x and y positions in a plane 642 substantially parallel to a floor of an instrument deck. A plurality of height actuators are configured to move each of the teaching pendants 601 independently in a direction 644 substantially perpendicular to the plane, wherein the teaching pendants 601 contact teaching objects on or above the instrument deck as a result of the position of the array of the teaching pendants.

Automated library generator 200 may include multiple arrays of teaching objects or datums located throughout the deck area for the teaching pendants to detect and contact with. In some embodiments, an array of teaching objects are placed on, above, below, or adjacent to a labware, deck object, or module, such as a module for loading consumables, including reagent reservoirs, plates (e.g., polymerase chain reaction (PCR) plates and deep well plates), tubes, and the like. By placing an array of teaching objects close to a labware or module, the results from detecting the array of teaching objects with the teaching pendants may be used to adjust and calibrate a reference position of the module or the reference positions of different portions or components of the module. For example, with reference to FIG. 2, the position of the reagent module 240 may be specified by a reference position (also referred to as the reference A1 position of the module) corresponding to the reagent module 240. The reference position may be recorded as a set of offset distances in the x, y, and z axes measured from the reference position to a master reference point within deck area 201. The results from detecting an array of teaching objects located on or close to reagent module 240 with the array of teaching pendants may be used to adjust and calibrate the reference A1 position of reagent module 240 or the reference positions of different portions of reagent module 240, such as the row 242 of eight wells of the reagent module 240.

In some embodiments, an array of teaching objects may be used to adjust and calibrate the reference position of magnetic separator plate 214 in FIG. 2. An array of magnets 218 is located above magnetic separator plate 214. Arrays of wells, tips, or tubes may be placed above the array of magnets 218. In some embodiments, a magnetic separator plate adapter 217 may be mounted on top of the magnetic separator plate 214 to keep the array of tips/tubes stable and sitting at the exact locations. The magnetic separator plate adapter 217 may rest above the magnetic separator plate 214 and the array of magnets 218. Magnetic separator plate adapter 217 may include a plurality of teaching objects 216.

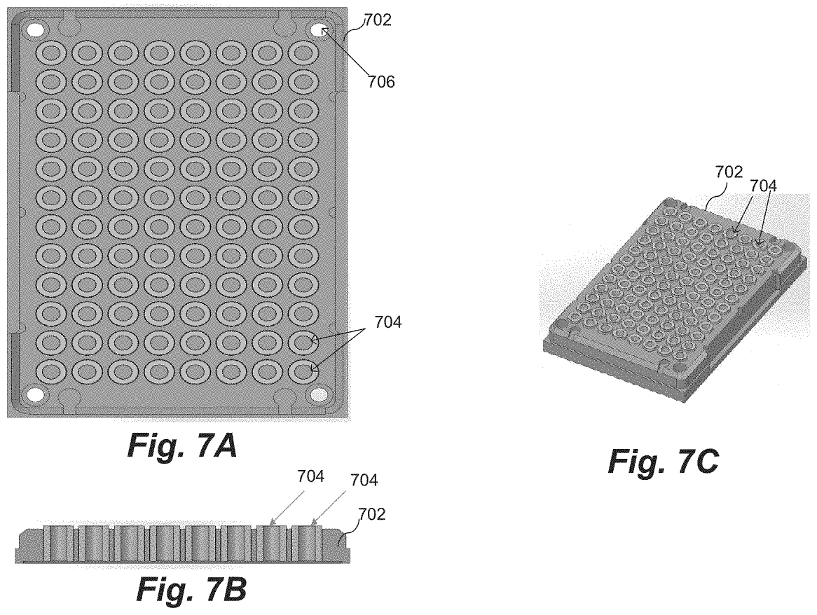

FIG. 7A illustrates a top view of an embodiment of a magnetic separator plate 702. FIG. 7B illustrates a cross sectional view of the magnetic separator plate 702. FIG. 7C illustrates another view of the magnetic separator plate 702.

As shown in FIG. 7A, magnetic separator plate 702 is a magnet holder plate that holds an array of magnets 704. Magnetic separator plate 702 is a 96-ring magnet plate, and the array of magnets 704 is an 8×12 array of magnets with eight magnets in a row and twelve magnets in a column. In some embodiments, each of the magnets 704 is a ring magnet. As shown in FIG. 7B, a ring magnet may be a magnet with a shape of a hollow cylinder that is empty from inside and with differing internal and external radii. The hollow space of the cylinder allows a bottom end of a tube to be inserted therein. For example, a tube received by a ring magnet may be a finger-like length of glass or plastic tubing that is open at the top and closed at the bottom. The position of the magnetic separator plate 702 may be specified by a reference position 706 (also referred to as the reference A1 position of the module) corresponding to the magnetic separator plate 702. The reference position may be recorded as a set of offset distances in the x, y, and z axes measured from the reference position 706 to a master reference point within the deck area.

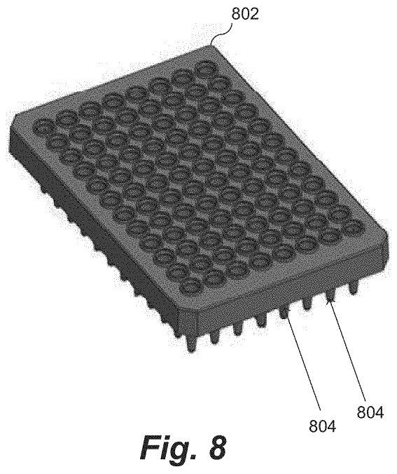

FIG. 8 illustrates an exemplary consumable 802 that may be loaded onto the magnetic separator plate 214 or magnetic separator plate 702 where magnetic bead-based cleanup may be performed. In this example, consumable 802 is a 96-tube polymerase chain reaction (PCR) tube holder plate with an array of tubes 804 arranged as an 8×12 array of tubes with eight tubes in a row and twelve tubes in a column.

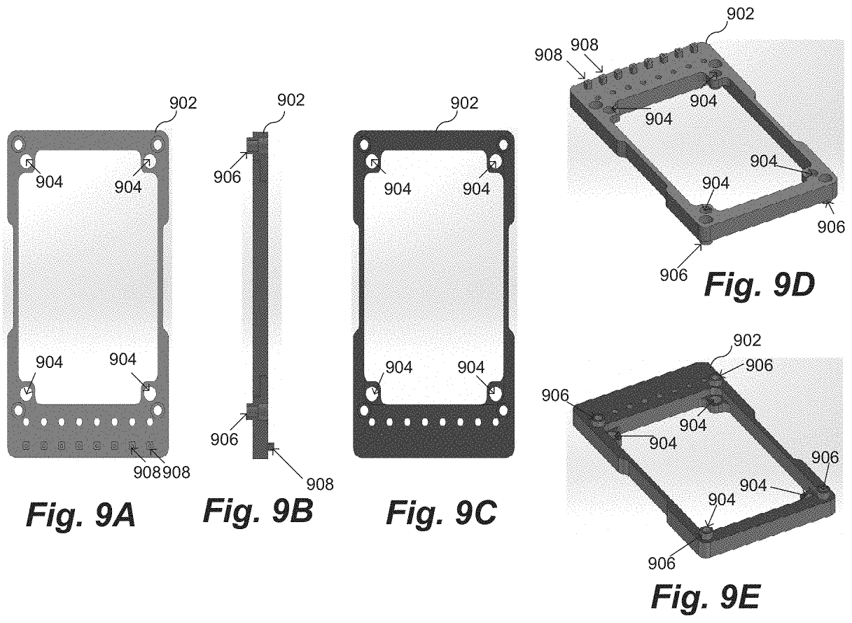

FIG. 9A illustrates a top view of a magnetic separator plate adapter 902. FIG. 9B illustrates a cross sectional view of the magnetic separator plate adapter 902. FIG. 9C illustrates a bottom view of the magnetic separator plate adapter 902. FIG. 9D illustrates another view of the top surface of the magnetic separator plate adapter 902. FIG. 9E illustrates another view of the bottom surface of the magnetic separator plate adapter 902. As shown in FIG. 9A, magnetic separator plate adapter 902 includes four collars 904 at the four corners of the adapter. The collars 904 may be used to fix the location (the x and y location on the deck) of a consumable, such as a 96-tube PCR plate. For example, each of the collars 904 constrains the x location and the y location of the tube holder plate by having a tube inserted into the collar. The magnetic separator plate adapter 902 further includes four cylindrical feet 906 at the four corners of the adapter, such that the magnetic separator plate adapter 902 may be mounted on the magnetic separator plate 702. In some embodiments, magnetic separator plate adapter 902 may be formed of plastic and includes skirts. Magnetic separator plate adapter 902 may include a plurality of teaching objects 908.

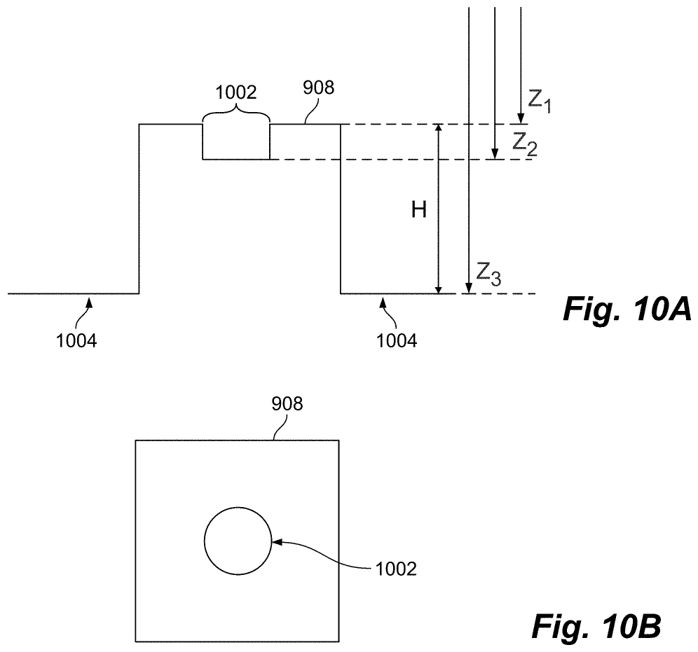

FIG. 10A illustrates a cross sectional view of a teaching object 908. FIG. 10B illustrates a top view of teaching object 908. In some embodiments, teaching object 908 is a post that is standing upright on a floor 1004. The post may be a rectangular prism, cube, cylinder, and the like. In some embodiments, the post may be formed with a metal. In some embodiments, a teaching object 908 includes an opening or hole 1002 that is located at substantially the center of the top surface of the teaching object. The hole may have a shape of a cylinder, rectangular prism, cube, and the like. In some embodiments, the hole may have a cross sectional area that is smaller than that of the tip of a teaching pendant, such that the teaching pendant may be inserted into the hole when the hole and the teaching pendant are substantially aligned with each other. Different surfaces of the post and different surfaces that are adjacent to the post may be contacted and detected by a teaching pendant. For example, the surfaces detected may include the top surface of the post, the inner surfaces of the opening 1002, and the floor 1004 that is adjacent to the post. When the teaching pendant detects a surface, the location of the teaching pendant (i.e., its x, y, and z positions) may be determined and recorded. For example, the z positions when the teaching pendant touches the top surface of the post 908, the bottom inner surface of the opening 1002, and the floor 1004 are Z₁, Z₂, and Z₃, respectively. Z₃ is equal to Z₁+H, where H is the height of the post 908.

Different techniques may be used to detect a teaching object or other surfaces surrounding the teaching object by a teaching pendant. Automated library generator 200 may include circuitries or logic for detecting the teaching objects or other surfaces surrounding the teaching objects and determining the heights (or z positions) where the detections occur. System 200 may further include circuitries or logic for controlling the actuators in response to the detections. In some embodiments, measurements of a combination of capacitance and conductivity while the teaching pendant is moving toward the teaching object or other surfaces may be used to detect the teaching object or other surfaces surrounding the teaching object. In some embodiments, measurements of a combination of pressure and capacitance while the teaching pendant is moving toward the teaching object or other surfaces may be used to detect the teaching object or other surfaces surrounding the teaching object. In some embodiments, measurements of the torque of the height actuator or the current driving the height actuator while the teaching pendant is moving toward the teaching object or other surfaces may be used to detect the teaching object or other surfaces surrounding the teaching object. After a surface is detected by a teaching pendant, the height actuator may be configured to stop the teaching pendant from moving further downward in the z direction, thereby preventing the teaching pendant, the height actuator, or other surfaces from being damaged.

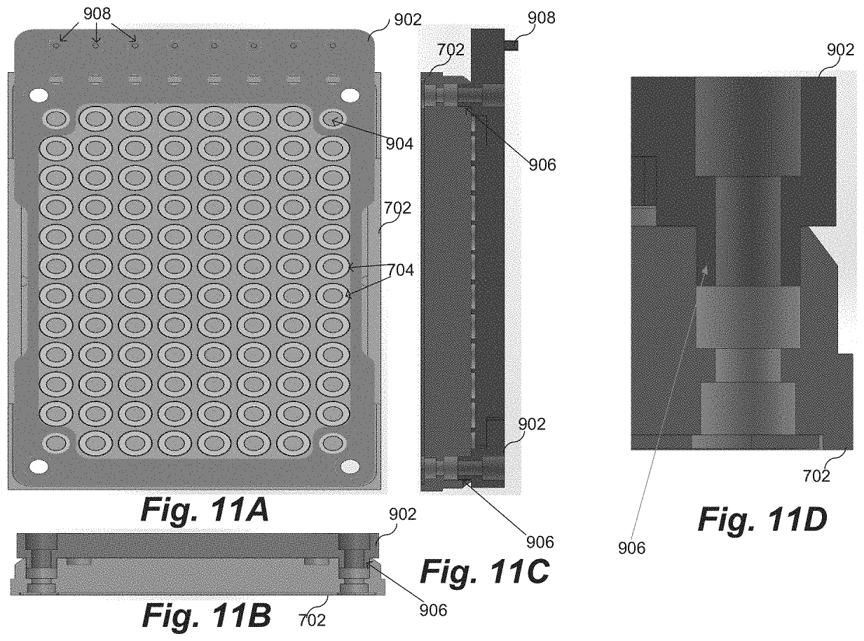

FIG. 11A illustrates a top view of the magnetic separator plate adapter 902 being loaded onto the magnetic separator plate 702. FIG. 11B illustrates a cross sectional view of the magnetic separator plate adapter 902 being loaded onto the magnetic separator plate 702. FIG. 11C illustrates another cross sectional view of the magnetic separator plate adapter 902 being loaded onto the magnetic separator plate 702. FIG. 11D illustrates a portion of a magnified cross sectional view of the magnetic separator plate adapter 902 being loaded onto the magnetic separator plate 702. As shown in FIGS. 11B, 11C, and 11D, a cylindrical foot 906 of the magnetic separator plate adapter 902 fits into a cylindrical hole on the magnetic separator plate 702, thereby mounting the magnetic separator plate adapter 902 on the magnetic separator plate 702 and raising the magnetic separator plate adapter 902 above the magnetic separator plate 702.

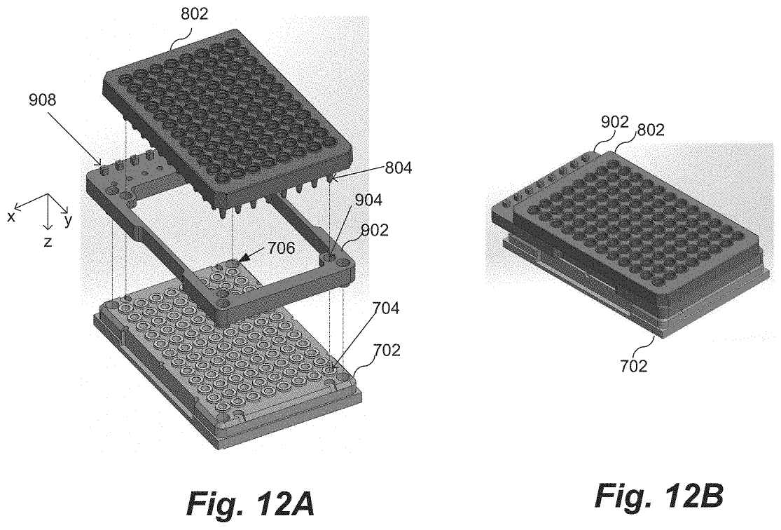

FIG. 12A illustrates a view of the magnetic separator plate adapter 902 about to be loaded onto the magnetic separator plate 702 and the 96-tube PCR plate 802 about to be loaded onto the magnetic separator plate adapter 902. FIG. 12B illustrates another view of the magnetic separator plate adapter 902 being loaded onto the magnetic separator plate 702 and the 96-tube PCR plate 802 being loaded onto the magnetic separator plate adapter 902. As shown in FIG. 12A, the reference position 706 corresponding to the magnetic separator plate 702 is below the array of teaching objects 908 in the z direction. Each of the teaching objects 908 has a different offset from the reference position 706 in the x direction, and each of the teaching objects 908 has substantially the same offset from the reference position 706 in the y direction. Therefore, the reference position 706 may be adjusted based on the results from detecting the array of teaching objects 908 with the array of teaching pendants.

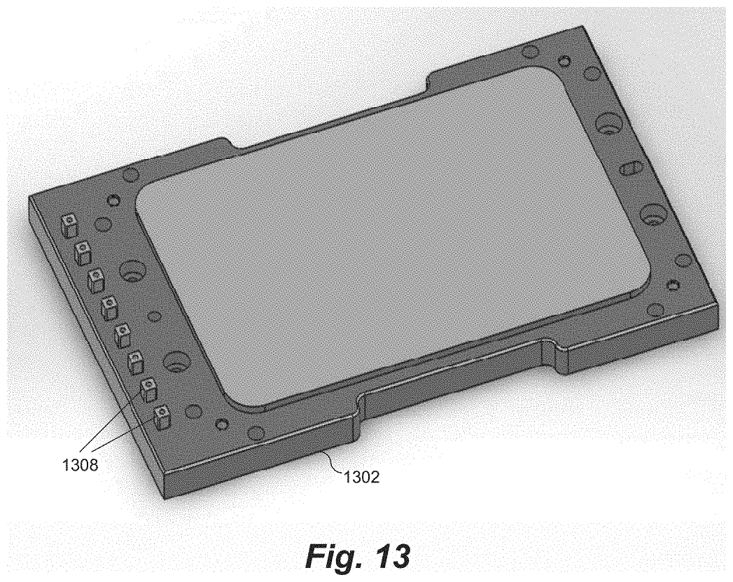

FIG. 13 illustrates another embodiment of a magnetic separator plate adapter 1302. The magnetic separator plate adapter 1302 includes an array of eight teaching objects 1308.

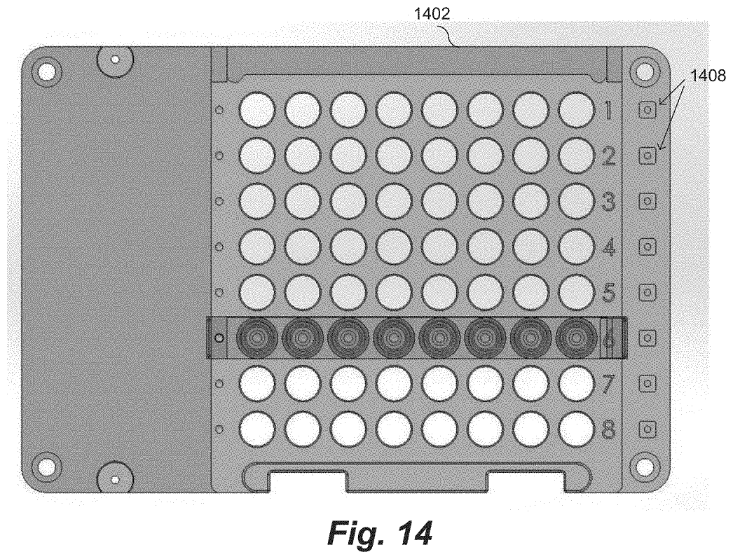

FIG. 14 illustrates another embodiment of a module 1402. The module 1402 includes an array of eight teaching objects 1408.

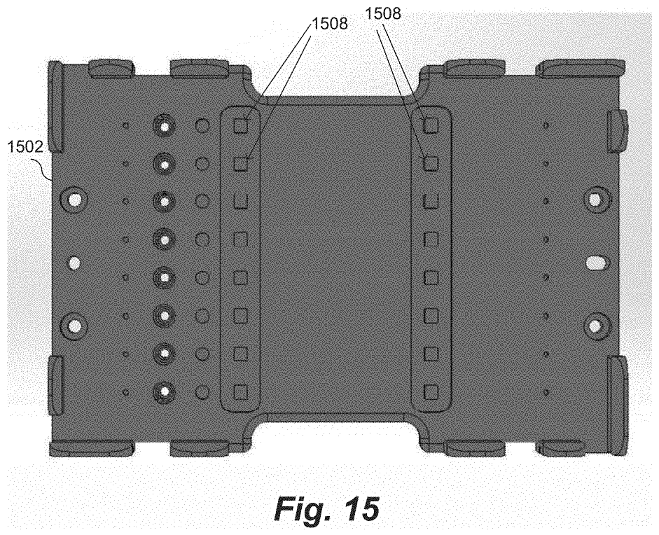

FIG. 15 illustrates another embodiment of a module 1502. The module 1502 includes two arrays of eight teaching objects 1508.

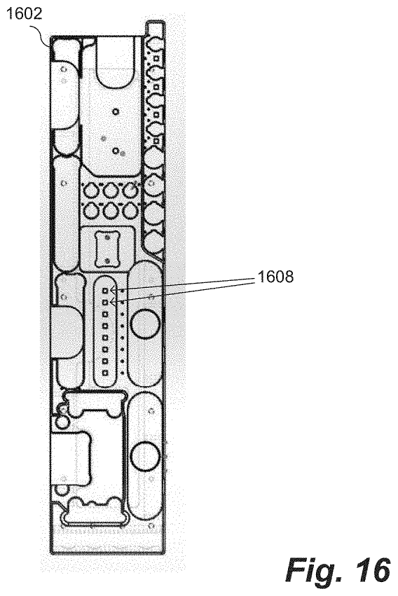

FIG. 16 illustrates another embodiment of a module 1602. The module 1602 includes an array of eight teaching objects 1608 that are located substantially at the center of the module 1602.

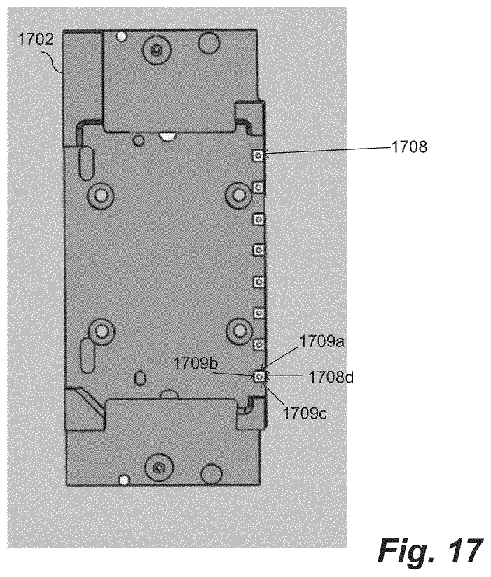

FIG. 17 illustrates another embodiment of a module 1702. The module 1702 includes an array of eight teaching posts 1708 that are located on the right periphery of the module 1702. As shown in FIG. 17, a teaching post 1708 is a rectangular prism standing on the module floor. As shown in a top view, only the bases of three vertical surfaces of a teaching post 1708 (1709a, 1709b, and 1709c) are adjacent to and intersecting with the module floor. The base 1709d of the right vertical surface of the teaching post 1708 is not adjacent to any portion of the module floor surface. As a result, when a teaching pendant is lowered by the actuator in the z direction to detect a teaching post but is offset from the teaching post to the right, the teaching pendant will miss the top surface of the teaching post and will continuously go further in the z direction without hitting the module floor. In this case, a large z value corresponding to the teaching pendant may be recorded even when no surfaces have been detected.

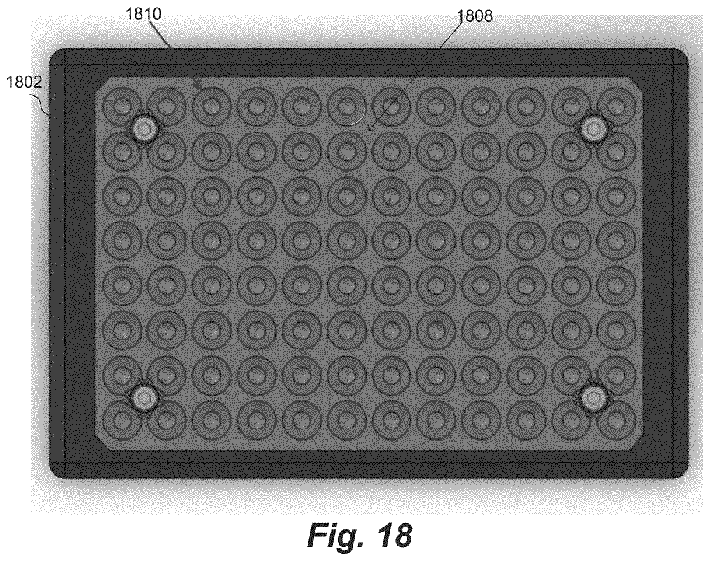

In some embodiments, existing features, surfaces, or components of a module may be utilized as the teaching objects. FIG. 18 illustrates an embodiment of a module 1802 with features, surfaces, or components that may be utilized as teaching objects. Module 1802 is an incubation module that includes a rectangular array of wells 1810. Each well 1810 has a shape of a cylinder. However, other embodiments may have wells with the shape of a rectangular prism, cube, and the like. Different surfaces of module 1802 may be contacted and detected by a teaching pendant. For example, the top surfaces of module 1802, such as the surfaces 1808 surrounding each of the wells 1810, may serve as target teaching objects. Other surfaces that may be detected include the inner surfaces of the wells 1810. When an inner surface of a well 1810 is detected, it indicates that the teaching pendant has missed the target teaching object, i.e., the surface 1808 surrounding the well 1810. When the teaching pendant detects a surface, the location of the teaching pendant (i.e., its x, y, and z positions) may be determined and recorded. Alternatively, the inner surfaces of the wells 1810 may serve as target teaching objects. When the surfaces 1808 surrounding each of the wells 1810 are detected, it indicates that the teaching pendant has missed the target teaching object, i.e., the inner surfaces of the well 1810.

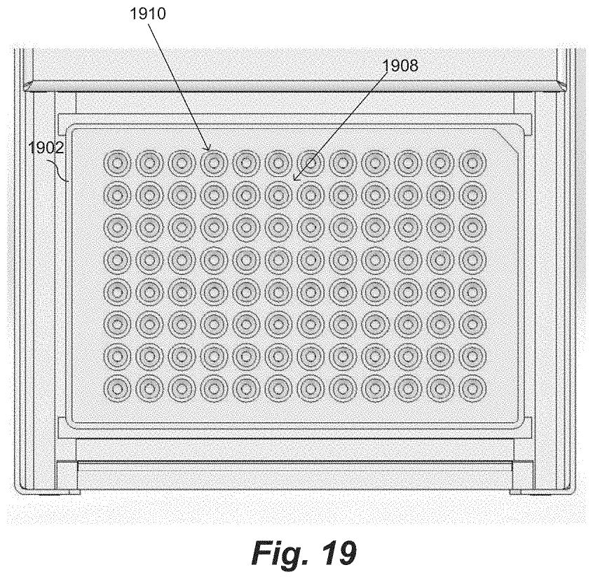

FIG. 19 illustrates another embodiment of a module 1902 with features, surfaces, or components that may be utilized as teaching objects. Module 1902 is a module that includes a rectangular array of wells 1910. Each well 1910 has a shape of a cylinder. Different surfaces of module 1902 may be contacted and detected by a teaching pendant. For example, the top surfaces of module 1902, such as the surfaces 1908 surrounding each of the wells 1910, may serve as target teaching objects.

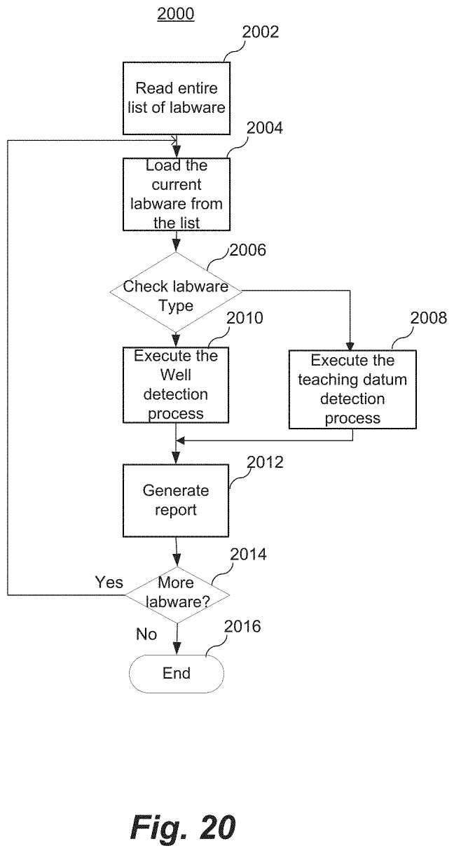

FIG. 20 illustrates an embodiment of a process 2000 for automatically calibrating the positioning of a liquid handling gantry with a pipetting head.

At step 2002, the entire list of labware of the system is read. Automated library generator 200 includes five carriers (202, 204, 206, 208, and 210) on the deck 201. Each of the carriers may be loaded with different types of labware, modules, deck objects, and consumables, such as a magnetic separator plate, a thermal cycler block, tips, reagent reservoirs, plates (e.g., polymerase chain reaction (PCR) plates and deep well plates), tubes, and the like. In some embodiments, automated library generator 200 stores a set of information corresponding to each piece of labware or module in a database or file. The stored information for each piece of labware may include the type of labware or deck object, its reference position, or the reference positions of different portions or components of that piece of labware. The stored information may also include the reference positions (x, y, and z positions) and the height of the teaching objects for calibrating the piece of labware. For example, with reference to FIG. 2, the stored information for the reagent module 240 may include the reference position of the reagent module 240 (also referred to as the reference A1 position of the reagent module) and the reference positions of different portions of reagent module 240, such as the row 242 of eight wells of the reagent module 240. These reference positions may be recorded as a set of offset distances in the x, y, and z axes measured from a master reference point within deck area 201. However, the reference A1 positions of at least some of the labware in the system may not be accurate. Therefore, process 2000 is performed to recalculate the reference A1 positions, thereby maintaining a high level of accuracy and precision in the automated library generator.

At step 2004, information corresponding to the current piece of labware on the list is loaded into the system. At step 2006, the type of labware is determined based on the information corresponding to the current piece of labware. For some types of labware, the process proceeds to step 2008, and for other types of labware, process 2000 proceeds to step 2010.

At step 2008, a teaching datum detection process is performed. The teaching datum detection process uses an array of teaching pendants to detect an array of teaching datums, such as the teaching datums as shown in FIGS. 10A and 10B. The teaching datum detection process will be described in greater detail below.

At step 2010, a well detection process is performed. The well detection process uses the array of teaching pendants to detect an array of wells and the surfaces surrounding the wells in certain types of labware, such as the labware as shown in FIGS. 18 and 19. The well detection process will be described in greater detail below.

After step 2008 or step 2010 is performed, process 2000 proceeds to step 2012. At step 2012, the results from the teaching datum detection process or the well detection process are stored in a report, such as in a file or in a database.

At step 2014, it is determined whether there are any additional pieces of labware on the list that have not been processed. If there is another piece of labware to be processed, then process 2000 proceeds back to step 2004; otherwise, process 2000 proceeds to step 2016 and the process is terminated.

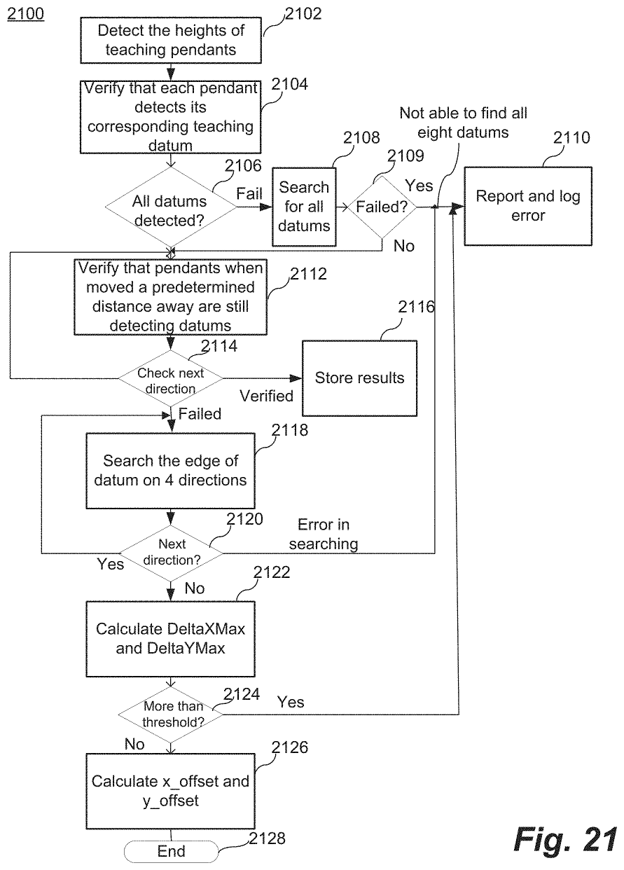

FIG. 21 illustrates an embodiment of a teaching datum detection process 2100. Process 2100 may be executed by step 2008 of process 2000 as shown in FIG. 20. Teaching datum detection process 2100 uses an array of teaching pendants to detect an array of teaching datums, such as the teaching datum as shown in FIGS. 10A and 10B.

At step 2102, the heights (or z positions) of the array of teaching pendants when the teaching pendants are translated to the x and y positions of the teaching datums are determined. For example, as shown in FIG. 6, a linear array of teaching pendants 601 is coupled to an 8-channel pipetting head 602 of liquid handling gantry 638. One or more actuators 640 may be used to move the x, y, and z positions of each of the teaching pendants 601. A translation actuator may be configured to translate the array of teaching pendants 601 to different x and y positions in a plane 642 substantially parallel to a floor of an instrument deck. The stored information for the current piece of labware includes the positions of the teaching datums for calibrating the piece of labware. Therefore, the translation actuator may be configured to translate the array of teaching pendants 601 to the x and y positions corresponding to the array of teaching datums.

A plurality of height actuators is then configured to move each of the teaching pendants 601 independently in a direction 644 substantially perpendicular to the plane to detect the array of teaching datums. Different surfaces of the datum and different surfaces that are adjacent to the datum may be contacted and detected by a teaching pendant. For example, the surfaces detected may include the top surface of the datum, the inner surfaces of the opening 1002, and the floor 1004 that is adjacent to the datum. When the teaching pendant detects a surface, the z position or the height of the teaching pendant may be determined and recorded. For example, as shown in FIG. 10A, the z positions when the teaching pendant touches the top surface of the post 908, the bottom inner surface of the opening 1002, and the floor 1004 are Z₁, Z₂, and Z₃, respectively. The value Z₃ is equal to Z₁+H, where H is the height of the post 908.

For some types of labware, a large z value corresponding to the teaching pendant may be recorded even when no surfaces have been detected by the teaching pendant. For example, as shown in FIG. 17, the base 1709d of the right vertical surface of the teaching post 1708 is not adjacent to any portion of the module floor surface. As a result, when a teaching pendant is lowered by the actuator in the z direction to detect a teaching post 1708 but is offset from the teaching post to the right, the teaching pendant will miss the top surface of the teaching post and will continuously go further in the z direction without hitting the module floor. In this case, a large z value corresponding to the teaching pendant is recorded even when no surfaces have been detected by the teaching pendant. For example, the z value may be greater than a threshold value, such as Z₁+H, where Z₁ is the z value at the top surface of the teaching post 1708, and H is the height of the post 1708.

At step 2104, the detected heights of the array of teaching pendants when the teaching pendants are translated to the x and y positions of the teaching datums are used to determine whether the teaching pendants detect their corresponding teaching datums. In some embodiments, a detected z value of a teaching pendant that is greater than a predetermined threshold indicates that the teaching pendant failed to detect its corresponding teaching datum, whereas a detected z value of a teaching pendant that is smaller than or substantially equal to the predetermined threshold indicates that the teaching pendant has detected its corresponding teaching datum. The predetermined threshold may be selected based on different factors, such as the type of the labware, the height of the teaching datum, the physical features and shapes of the teaching datum, and the like. For example, with reference to FIG. 10A, if the teaching datum has an opening or hole 1002 that is located at substantially the center of the top surface of the teaching datum, then a z value that is greater than Z₂ indicates that the teaching pendant failed to detect its corresponding teaching datum. However, if the teaching datum does not have an opening or hole that is located at substantially the center of the top surface of the teaching datum, then a z value that is greater than Z₁ indicates that the teaching pendant failed to detect its corresponding teaching datum.

At step 2106, it is determined whether the entire array of teaching datums is detected. If only some of the teaching datums are detected, then the positioning of the liquid handling gantry with the pipetting head based on the stored reference positions is significantly misaligned. Accordingly, process 2100 proceeds to step 2108. At step 2108, a search for the teaching datums is performed. If the search fails at step 2109, process 2100 proceeds to step 2110, such that an error is logged and reported. If the entire array of teaching datums is detected, then process 2100 proceeds to step 2112.

At step 2112, the array of teaching pendants is translated by a predetermined distance to verify that the array of teaching pendants is still able to engage and touch the array of teaching datums when the array of teaching pendants is being lowered in the z direction. If the positioning of the liquid handling gantry with the pipetting head is reasonably accurate, then initially each teaching pendant should be in relatively close contact with the center of the top surface of its corresponding teaching datum. Since the cross sectional area of the top surface of a teaching datum is greater than that of the tip of a teaching pendant, translating the array of teaching pendants by a predetermined distance away from its current position should still allow the array of teaching pendants to engage and touch the array of teaching datums. Therefore, the verification at step 2112 indicates that the positioning of the liquid handling gantry with the pipetting head is reasonably accurate.

In some embodiments, the array of teaching pendants is translated by a predetermined distance in a plurality of directions, and after each translation in one direction, it is verified that the array of teaching pendants is still engaging and touching the array of teaching datums. In some embodiments, the array of teaching pendants is translated by 1 mm in four different directions (+x, −x, +y, and −y) from its original stored reference position, and after each translation in one direction, it is verified that the array of teaching pendants is still able to engage and touch the array of teaching datums.

If each direction is validated at 2114, then process 2100 proceeds to step 2116 and the results are logged into a report. However, if at least one direction fails, then process 2100 proceeds to step 2118, wherein the process enters a teaching phase to estimate the center points or new reference positions of the teaching datums.

At step 2118, the edges or boundaries of the teaching datums are determined. For example, the left, right, upper, and lower edges of the teaching datums as viewed from the top are determined. In some embodiments, starting from its original stored reference position, the array of teaching pendants is translated by a predetermined distance in one direction and, after each translation, it is determined whether each of the teaching pendants is still able to engage and touch its corresponding teaching datum when the teaching pendant is lowered in the z direction. The incremental movement of the array of teaching pendants by the predetermined distance in one direction is continued until all of the teaching pendants are no longer engaging and touching their corresponding teaching datums. The total distance that each teaching pendant is moved in that direction until it no longer engages and touches its corresponding teaching datum is then recorded for each channel. This is the distance of each teaching pendant from its original reference position to the edge of its corresponding teaching datum in one direction. The same procedure is repeated for all four directions (+x, −x, +y, and −y) from the array's original stored reference position.

For example, the array of teaching pendants may be translated by predetermined distance (e.g., 0.5 mm) in the +x direction (i.e., to the right) each time until all of the teaching pendants are no longer engaging and touching their corresponding teaching datums. The total distance that each teaching pendant is moved in the +x direction until it no longer engages and touches its corresponding teaching datum is then recorded for each channel. The distance for the i^{th} channel is distance_right(i). With the recorded total distance for each channel, the x position of the right edge of the teaching datum, x_right(i), is determined based on the distance and the teaching datum's original reference position (x_ref(i), y_ref(i)), wherein x_right(i)=x_ref(i)+distance_right(i).

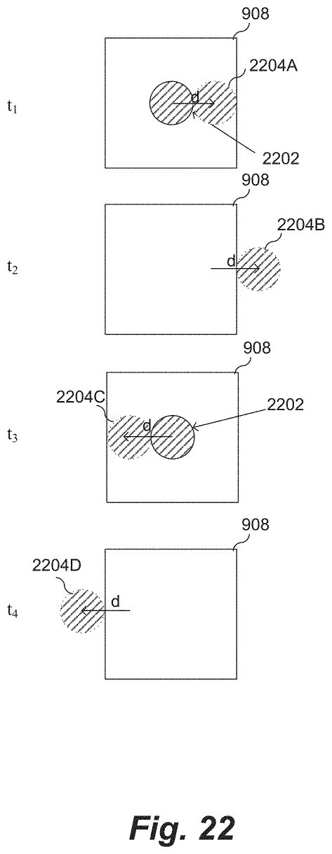

FIG. 22 illustrates an example of determining the left and right edges of a teaching datum 908 in channel #1. At t₁, a teaching pendant is moved from its original reference position 2202 (x_ref(1), y_ref(1)) to the right by a fixed distance (d) to position 2204A. At position 2204A, the teaching pendant touches the top surface of the teaching datum 908. At t₂, the teaching pendant is then translated by another fixed distance (d) to position 2204B. At position 2204B, the teaching pendant no longer touches the top surface of the teaching datum 908. The total distance that the teaching pendant is moved to the right (distance_right(1)) is then recorded for this channel. In particular, x_right(1)=x_ref(1)+distance_right(1).

The array of teaching pendants is translated back to its original reference position. The array is then translated by a predetermined distance (e.g., 0.5 mm) in the −x direction (i.e., to the left) each time until all of the teaching pendants are no longer engaging and touching their corresponding teaching datums. The total distance that each teaching pendant has moved in the −x direction until it no longer engages and touches its corresponding teaching datum is then recorded for each channel. The distance for the i^{th} channel is distance_left(i). With the recorded total distance for each channel, the x position of the left edge of the teaching datum, x_left(i), is determined based on the distance and the teaching datum's original reference position (x_ref(i), y_ref(i)), wherein x_left(i)=x_ref(i)−distance_left(i).

With continued reference to FIG. 22, at t₃, a teaching pendant is moved from its original reference position 2202 (x_ref(1), y_ref(1)) to the left by a fixed distance (d) to position 2204C. At position 2204C, the teaching pendant touches the top surface of the teaching datum 908. At t₄, the teaching pendant is then translated by another fixed distance (d) to position 2204D. At position 2204D, the teaching pendant no longer touches the top surface of the teaching datum 908. The total distance that the teaching pendant has moved to the left (distance_left(1)) is then recorded for this channel. In particular, x_left(1)=x_ref(1)−distance_left(1).

The array of teaching pendants is translated back to its original reference position. The array is then translated by 0.5 mm in the +y direction (i.e., in the up direction) each time until all of the teaching pendants are no longer engaging and touching their corresponding teaching datums. The total distance that each teaching pendant has moved in the +y direction before it no longer engages and touches its corresponding teaching datum is then recorded for each channel. The distance for the i^{th} channel is distance_up(i). With the recorded total distance for each channel, the y position of the upper edge of the teaching datum, y_up(i), is determined based on the distance and the teaching datum's original reference position (x_ref(i), y_ref(i)), wherein y_up(i)=y_ref(i)+distance_up(i).

The array of teaching pendants is translated back to its original reference position. The array is then translated by 0.5 mm in the −y direction (i.e., in the down direction) each time until all of the teaching pendants are no longer engaging and touching their corresponding teaching datums. The total distance that each teaching pendant has moved in the −y direction before it no longer engages and touches its corresponding teaching datum is then recorded for each channel. The distance for the i^{th} channel is distance_down(i). With the recorded total distance for each channel, the y position of the lower edge of the teaching datum, y_down(i), is determined based on the distance and the teaching datum's original reference position (x_ref(i), y_ref(i)), wherein y_down(i)=y_ref(i)−distance_down(i).

At 2120, after all four edges of the teaching datums are determined, process 2100 proceeds to step 2122. However, if there is an error finding the edge of at least one teaching datum, then process 2100 proceeds to step 2110, such that the error is logged and reported.

At step 2122, the maximum difference of the distance from a reference position of a teaching datum to the edge of the teaching pendant in the +x/−x directions for all channels, DeltaXMax, is determined. The maximum difference of the distance from a reference position of a teaching datum to the edge of the teaching pendant in the +y/−y directions for all channels, DeltaYMax, is determined.

At step 2124, if either DeltaXMax or DeltaYMax is greater than a predetermined threshold (e.g., 1.5 mm), it indicates that the reference position of at least one teaching datum is significantly far away from its actual position and, accordingly, process 2100 proceeds to step 2110, such that an error is logged and reported. Otherwise, process 2100 proceeds to step 2126.

At step 2126, the offset or adjustment in the x direction (x_offset) and the offset in the y direction (y_offset) are determined. After step 2126, process 2100 is completed and is terminated at 2128. These offset values may be used to correct the reference position of the labware or the reference positions of different portions or components of the labware. In some embodiments, the x and y positions of the center points of the teaching datums are estimated based on the edge detection results that are obtained at step 2118 above. The x and y values of the center point of a teaching datum for the i^{th} channel are x_center(i)=(x_left(i)+x_right(i))/2 and y_center(i)=(y_up(i)+y_low(i))/2, respectively. The offset from the original reference position of the teaching datum to the actual detected position of the teaching datum for the i^{th} channel is then determined based on the estimated center point of the i^{th} teaching datum and the original reference position of the i^{th} teaching datum. In particular, x_offset(i)=x_center(i)—x_ref(i) and y_offset(i)=y_center(i)—y_ref(i). In some embodiments, the offset values (x_offset and y_offset) that may be used to correct the reference position of the labware or the reference positions of different portions or components of the labware may be determined based on the x_offset(i) values and the y_offset(i) values above. For example, the offset values (x_offset and y_offset) that may be used to correct the reference position of the labware or the reference positions of different portions or components of the labware may be determined as an average of the x_offset(i) values and an average of the y_offset(i) values above.

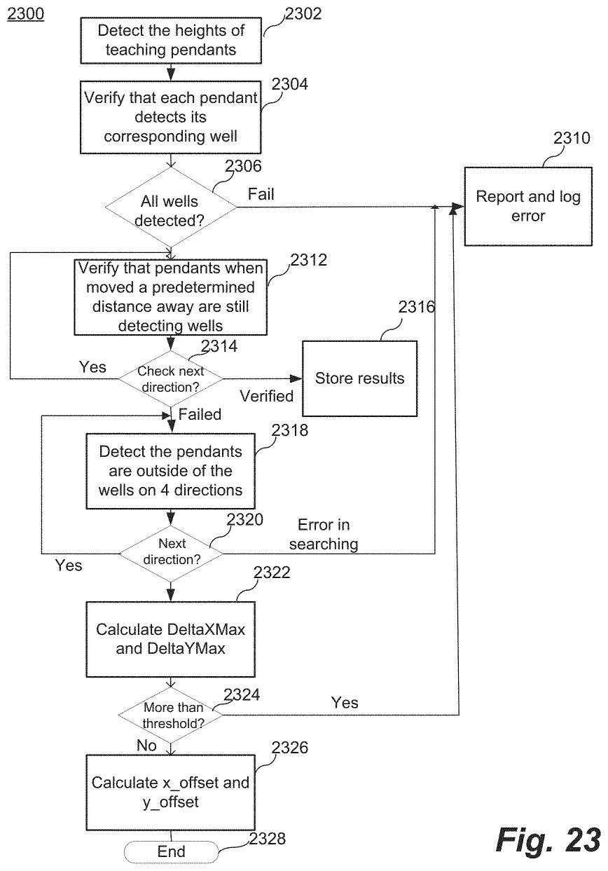

FIG. 23 illustrates an embodiment of a well detection process 2300. Process 2300 may be executed by step 2010 of process 2000 as shown in FIG. 20. Well detection process 2300 uses an array of teaching pendants to detect an array of wells, such as the wells in the modules as shown in FIGS. 18 and 19.

At step 2302, the heights (or z positions) of the array of teaching pendants when the teaching pendants are translated to the x and y positions of the wells are determined. For example, as shown in FIG. 6, a linear array of teaching pendants 601 is coupled to an 8-channel pipetting head 602 of liquid handling gantry 638. One or more actuators 640 may be used to move the x, y, and z positions of each of the teaching pendants 601. A translation actuator may be configured to translate the array of teaching pendants 601 to different x and y positions in a plane 642 substantially parallel to a floor of an instrument deck. The stored information for the current piece of labware includes the positions of the wells for calibrating the piece of labware. Therefore, the translation actuator may be configured to translate the array of teaching pendants 601 to the x and y positions corresponding to a row of wells.

A plurality of height actuators is then configured to move each of the teaching pendants 601 independently in a direction 644 substantially perpendicular to the plane to detect the array of wells. Different surfaces of the well and different surfaces that are adjacent to the well may be contacted and detected by a teaching pendant. For example, the inner surfaces of the wells 1810 may serve as target teaching objects. When the surfaces 1808 surrounding each of the wells 1810 are detected, it indicates that the teaching pendant has missed the target teaching object, i.e., the inner surfaces of the well 1810. When the teaching pendant detects a surface, the z position or the height of the teaching pendant may be determined and recorded. For example, the z positions when the teaching pendant touches the surfaces 1808 surrounding each of the wells 1810 and the bottom inner surface of each of the wells 1810 are Z₁ and Z₂, respectively. The value Z₂ is equal to Z₁+H, where H is the depth of the well 1810.

At step 2304, the detected heights of the array of teaching pendants when the teaching pendants are translated to the x and y positions of a row of wells are used to determine whether the teaching pendants detect their corresponding wells. In some embodiments, a detected z value of a teaching pendant that is smaller than a predetermined threshold indicates that the teaching pendant failed to detect its corresponding well. The predetermined threshold may be selected based on different factors, such as the type of the labware, the depth of the well, the physical features and shapes of the well, and the like. For example, a z value that is smaller than Z₂ (the z position when the teaching pendant touches the bottom inner surface of a well 1810) indicates that the teaching pendant failed to detect its corresponding well.

At step 2306, it is determined whether the entire linear array of wells is detected. If only some of the wells are detected, then the positioning of the liquid handling gantry with the pipetting head based on the stored reference positions is significantly misaligned. Accordingly, process 2300 proceeds to step 2310, such that an error is logged and reported. If the entire array of wells is detected, then process 2300 proceeds to step 2312.

At step 2312, the array of teaching pendants is translated by a predetermined distance to verify that the array of teaching pendants is still within the wells and is still engaging and touching the bottom inner surfaces of the wells. If the positioning of the liquid handling gantry with the pipetting head is reasonably accurate, then initially each teaching pendant should be in relatively close contact with the center of the bottom inner surface of its corresponding well. Since the cross sectional area of the bottom inner surface of a well is greater than that of the tip of a teaching pendant, translating the array of teaching pendants by a predetermined distance away from its current position should still allow the array of teaching pendants to stay within the wells and engage and touch the bottom inner surfaces of the wells. Therefore, the verification at step 2312 indicates that the positioning of the liquid handling gantry with the pipetting head is reasonably accurate.

In some embodiments, the array of teaching pendants is translated by a predetermined distance in a plurality of directions, and after each translation in one direction, it is verified that the array of teaching pendants may be lowered and still able to engage and touch the bottom inner surfaces of the wells. In some embodiments, the array of teaching pendants is translated by 1 mm in four different directions (+x, −x, +y, and −y) from its original stored reference position, and after each translation in one direction, it is verified that the array of teaching pendants may be lowered and is still able to engage and touch the bottom inner surfaces of the wells.

If each direction is validated at 2314, then process 2300 proceeds to step 2316 and the results are logged into a report. However, if at least one direction fails, then process 2300 proceeds to step 2318, when the process enters a teaching phase to estimate the center points of the wells.

At step 2318, the edges or boundaries of the wells are determined. For example, the left, right, upper, and lower edges of the wells as viewed from above are determined. In some embodiments, starting from its original stored reference position, the array of teaching pendants is translated by a predetermined distance in one direction, and after each translation, it is determined whether each of the teaching pendants is still within its corresponding well. The incremental movement of the array of teaching pendants by the predetermined distance in one direction is continued until all of the teaching pendants are no longer within their corresponding wells. The total distance that each teaching pendant is moved in that direction until it no longer stays within its corresponding well is then recorded for each channel. This is the distance of each teaching pendant from its original reference position to the edge of its corresponding well in one direction. The same procedure is repeated for all four directions (+x, −x, +y, and −y) from the array's original stored reference position.

For example, the array of teaching pendants is translated by 0.5 mm in the +x direction (i.e., to the right) each time until all of the teaching pendants are no longer detecting their corresponding wells. The total distance that each teaching pendant is moved in the +x direction until it is no longer within its corresponding well is then recorded for each channel. The distance for the i^{th} channel is distance_right(i). With the recorded total distance for each channel, the x position of the right edge of the well, x_right(i), is determined based on the distance and the well's original reference position (x_ref(i), y_ref(i)), wherein x_right(i)=x_ref(i)+distance_right(i).

The array of teaching pendants is translated back to its original reference position. The array is then translated by 0.5 mm in the −x direction (i.e., to the left) each time until all of the teaching pendants are no longer within their corresponding wells. The total distance that each teaching pendant is moved in the −x direction until it no longer detects its corresponding well is then recorded for each channel. The distance for the i^{th} channel is distance_left(i). With the recorded total distance for each channel, the x position of the left edge of the well, x_left(i), is determined based on the distance and the well's original reference position (x_ref(i), y_ref(i)), wherein x_left(i)=x_ref(i)−distance_left(i).

The array of teaching pendants is translated back to its original reference position. The array is then translated by 0.5 mm in the +y direction (i.e., in the up direction) each time until all of the teaching pendants are no longer within their corresponding wells. The total distance that each teaching pendant is moved in the +y direction before it no longer detects its corresponding well is then recorded for each channel. The distance for the i^{th} channel is distance_up(i). With the recorded total distance for each channel, the y position of the upper edge of the well, y_up(i), is determined based on the distance and the well's original reference position (x_ref(i), y_ref(i)), wherein y_up(i)=y_ref(i)+distance_up(i).

The array of teaching pendants is translated back to its original reference position. The array is then translated by 0.5 mm in the −y direction (i.e., in the down direction) each time until all of the teaching pendants are no longer within their corresponding wells. The total distance that each teaching pendant is moved in the −y direction before it no longer detects its corresponding well is then recorded for each channel. The distance for the i^{th} channel is distance_down(i). With the recorded total distance for each channel, the y position of the lower edge of the well, y_down(i), is determined based on the distance and the well's original reference position (x_ref(i), y_ref(i)), wherein y_down(i)=y_ref(i)−distance_down(i).

At 2320, after all four edges of the wells are determined, process 2300 proceeds to step 2322. However, if there is an error finding the edge of at least one well, then process 2300 proceeds to step 2310, such that the error is logged and reported.

At step 2322, the maximum difference of the distance from a reference position of a well to the edge of the well in the +x/−x directions for all channels, DeltaXMax, is determined. The maximum difference of the distance from a reference position of a well to the edge of the well in the +y/−y directions for all channels, DeltaYMax, is determined.

At step 2324, if either DeltaXMax or DeltaYMax is greater than a predetermined threshold (e.g., 1.5 mm), it indicates that the reference position of at least one well is significantly far away from its actual position, and accordingly, process 2300 proceeds to step 2310, such that an error is logged and reported. Otherwise, process 2300 proceeds to step 2326.

At step 2326, the offset or adjustment in the x direction (x_offset) and the offset in the y direction (y_offset) are determined. After step 2326, process 2300 is completed and is terminated at step 2328. These offset values may be used to correct the reference position of the labware or the reference positions of different portions or components of the labware. In some embodiments, the x and y positions of the center points of the wells are estimated based on the edge detection results that are obtained at step 2318 above. The x and y values of the center point of a well for the i^{th} channel are x_center(i)=(x_left(i)+x_right(i))/2 and y_center(i)=(y_up(i)+y_low(i))/2, respectively. The offset from the original reference position of the well to the actual detected position of the well for the i^{th} channel is then determined based on the estimated center point of the i^{th} well and the original reference position of the i^{th} well. In particular, x_offset(i)=x_center(i)—x_ref(i) and y_offset(i)=y_center(i)—y_ref(i). In some embodiments, the offset values (x_offset and y_offset) that may be used to correct the reference position of the labware or the reference positions of different portions or components of the labware may be determined based on the x_offset(i) values and the y_offset(i) values above. For example, the offset values (x_offset and y_offset) that may be used to correct the reference position of the labware or the reference positions of different portions or components of the labware may be determined as an average of the x_offset(i) values and an average of the y_offset(i) values above.

The improved techniques of automatically calibrating the positioning of the liquid handling gantry with the pipetting head presented herein have many advantages. These techniques enhance the throughput and the reproducibility of laboratory experiments. Furthermore, these techniques significantly reduce errors, thereby enhancing reproducibility. In addition, these techniques eliminate the need for users to manually teach the system. This also eliminates the need of using a single high precision position. For example, other techniques may keep one high precision position (golden position), and whenever a high precision measurement is needed, the tips are measured at the golden position only.

Reagents and consumables may be loaded onto the deck area at the beginning of each run. Consumables may include reagent reservoirs, plates (e.g., polymerase chain reaction (PCR) plates and deep well plates), tubes, and the like. However, loading the consumables onto the deck is prone to different types of errors. For example, consumables containing the wrong reagent may be loaded. In another example, consumables may be loaded at the wrong locations within the deck. In another example, consumables loaded onto the deck may be expired.

In the present application, a consumable tracking and error detection system is disclosed. The system comprises one or more barcode readers above an instrument deck. The system further comprises one or more mirrors on the instrument deck. The one or more barcode readers are controlled by a processor to read a plurality of barcodes on a plurality of objects on the instrument deck through the one or more mirrors.

In some embodiments, automated library generator 200 includes a consumable tracking and error detection system. The consumable tracking and error detection system may include one or more barcode readers for scanning barcodes that are placed at different locations of the deck and barcodes that are placed on different consumables. A barcode reader is an optical scanner that can read printed barcodes, decode the data contained in the barcode, and send the data to a computer. One or more barcode readers may be placed above the five carriers (202, 204, 206, 208, and 210) on deck 201. The consumable tracking and error detection system enables experiment tracking and prevents reagent mix-ups.

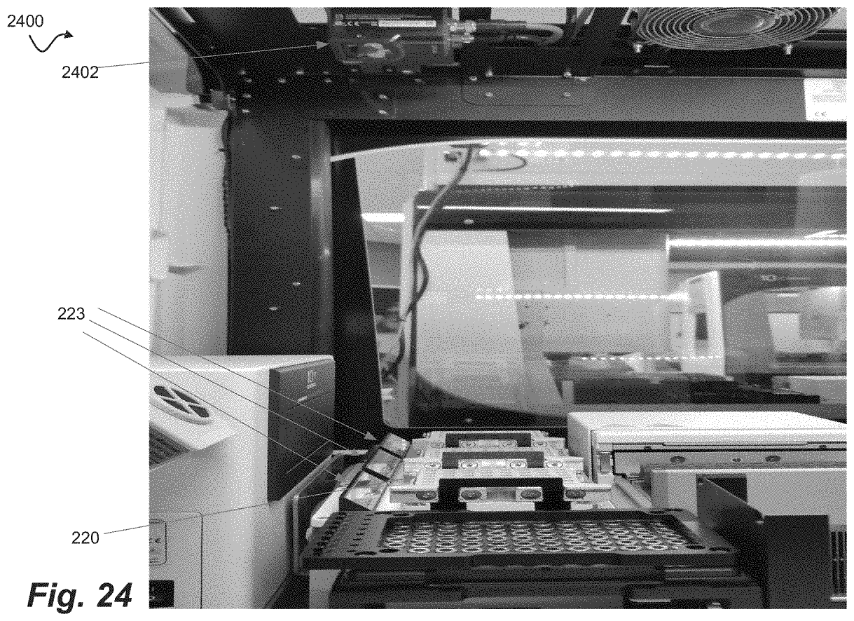

FIG. 24 illustrates one embodiment of a consumable tracking and error detection system 2400 for automated library generator 200. In this embodiment, two barcode readers 2402 may be placed above the leftmost carrier on the deck. The barcode readers 2402 may be used to read the barcodes on different types of labware, deck modules, or deck objects that are placed at different locations of the deck. The barcode readers 2402 may also be used to read the barcodes on consumables that are loaded onto different labware or deck modules, such as reagent reservoirs, plates (e.g., polymerase chain reaction (PCR) plates and deep well plates), tubes, and the like.

Consumable tracking and error detection system 2400 may further include a plurality of mirrors 223 to allow the barcode readers 2402 to read barcodes sideways and at more locations. For example, barcodes may be placed on the sides or vertical surfaces of the cold plate reagent module 220 or the consumables that are loaded onto the module, and the barcode readers 2402 may read the barcodes through the plurality of mirrors 223. The barcodes on the cold plate reagent module 220 may encode information that enables experiment tracking, such as the type of module, or the slot, row, or column number within the module. The barcodes on the consumables may encode information that enables experiment tracking, such as the color code, part number, lot number, expiration date of the reagent, and the like.

Reading the barcodes by the barcode readers through a plurality of mirrors has a number of advantages. One of the advantages is that the barcode readers do not need to occupy any deck space. Another advantage is that this enables the barcode readers to read from more locations on the deck. In particular, a barcode reader does not need to be placed on or close to the floor of the instrument deck, such that there is an unobstructed line of sight between the barcode reader and the barcode that is placed on the side or vertical surface of a labware, deck module, or consumable. Instead, a barcode reader may be placed anywhere above the instrument deck, such that the barcode reader has a sight along a line at the barcode's image, thereby enabling the barcode reader to view the image of the barcode in the mirror.

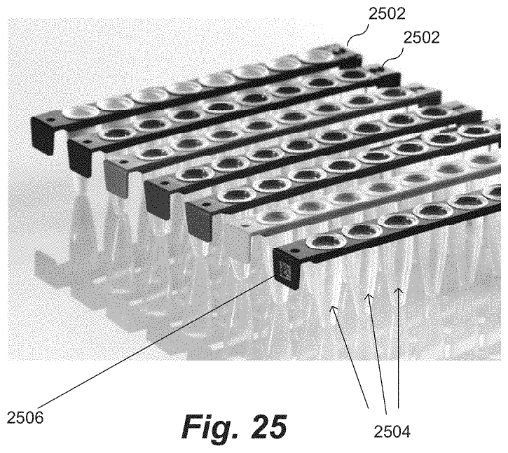

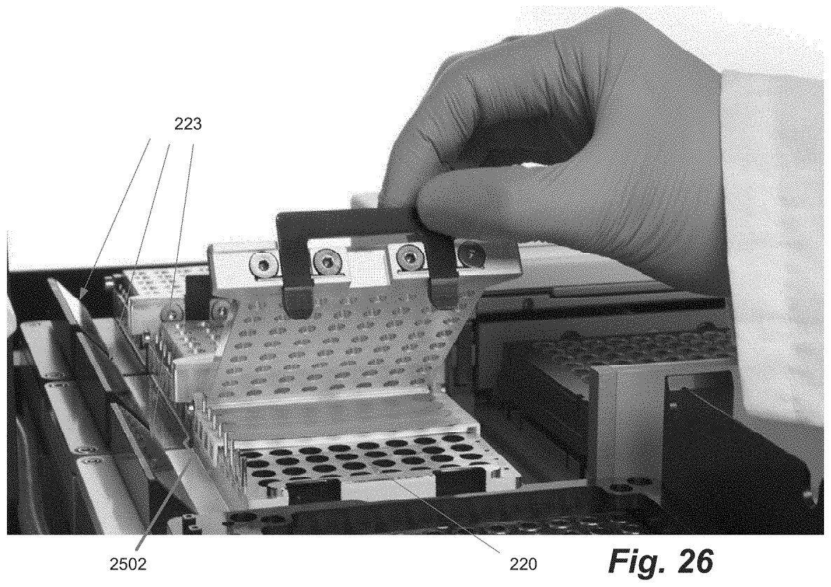

Barcodes may be placed on different types of consumables. FIG. 25 illustrates a plurality of strip tubes 2502 that may be loaded onto the cold plate reagent module 220. Each of the strip tubes 2502 includes eight tubes 2504. A barcode sticker 2506 may be added to a strip tube 2502. FIG. 26 illustrates that four strip tubes 2502 are loaded onto the cold plate reagent module 220.

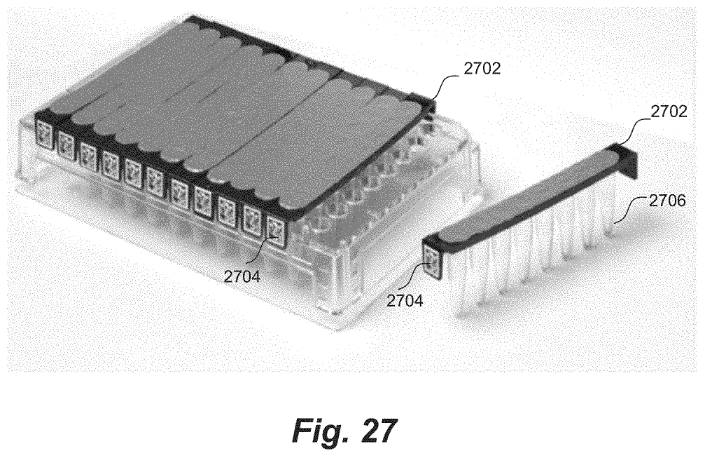

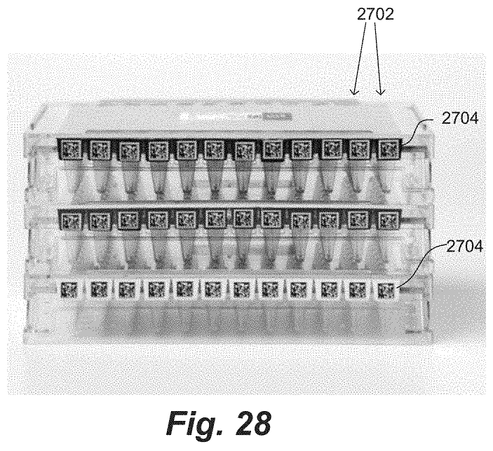

FIG. 27 illustrates one embodiment of one plate of an automated cell library and gel bead kit for the automated library generator 200. The kit may be tracked by the consumable tracking and error detection system 2400. FIG. 28 illustrates a plurality of plates of an automated cell library and gel bead kit for the automated library generator 200. In FIG. 28, the kit includes three plates; each plate is color-coded. For example, as shown in FIG. 28, the top plate is black, the middle plate is grey, and the bottom plate is white.

As shown in FIG. 27 and FIG. 28, each plate includes a plurality of strip tubes 2702. Each strip of tubes 2702 includes a plurality of tubes 2706 that are used to deliver a reagent. For example, each strip 2702 may include eight tubes 2706. Each strip 2702 is pre-aliquoted and color-coded. During each run, three strips 2702, one from each plate (black, grey, and white), may be used per sample. One to eight samples may be run at a time.

The benefit of using one strip per sample is that less or no reagent is wasted. In addition, strip 2702 is optimized for automated liquid handling within the automated library generator 200. The strips 2702 may be easily loaded on the carriers (shown in FIG. 2) on the deck.

To improve traceability, each strip 2702 may be labelled with a 2D barcode 2704 to prevent errors in handling the reagents or using reagents that are expired. In some embodiments, a barcode 2704 may encode different information for tracking the reagent lots and expiration dates. The encoded information may include the part number, lot number, expiration date of the reagent, and the like.

Consumable tracking and error detection system 2400 may include software logic to make sure that the correct consumables (with reagents) are put at the right slots or locations. Consumable tracking and error detection system 2400 may also detect that the consumables are missing such that the system may inform the user about these errors. The system may check for color matching, lot numbers, part numbers, and expiration dates.

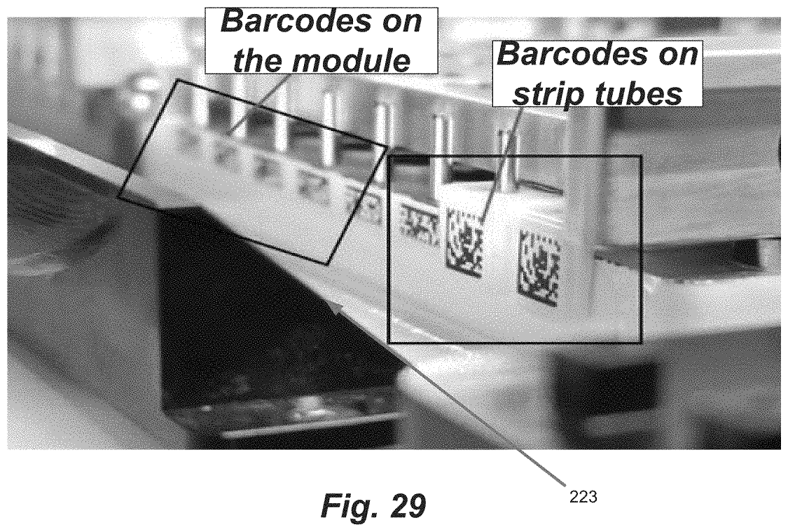

FIG. 29 illustrates that barcodes on the deck module and the barcodes on the consumables may be read by the barcode readers through a plurality of mirrors. In some embodiments, barcodes on the slots are covered by the strip tubes if they are put there. If the barcode reader reads the barcodes on the slots, then the slots are determined as being empty. If the barcode reader reads the barcodes on the strip tubes, then the system may match the two barcodes.

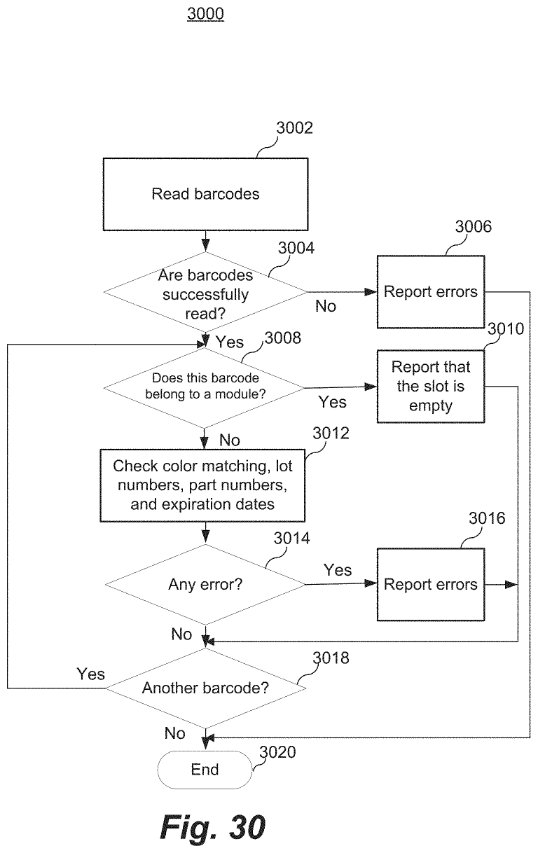

FIG. 30 illustrates an embodiment of a process 3000 for tracking consumables and detecting errors in loading the consumables in an automated library generator 200. At step 3002, a plurality of barcodes is read by the barcode reader. At step 3004, it is determined whether the barcodes are successfully read. If the barcodes are not successfully read, then it is determined that the barcode reader is not operating properly, and process 3000 proceeds to step 3006 to report the error; otherwise, process 3000 proceeds to step 3008. At step 3008, one of the barcodes read by the barcode reader is decoded to determine whether the barcode corresponds to a slot in a deck module. If the barcode is determined as corresponding to a slot in a deck module, then it is determined that the slot of the deck module does not have any consumables loaded and is empty. Accordingly, the slot is reported as empty at step 3010, and process 3000 proceeds to step 3018. If the barcode is determined as not corresponding to a slot in a deck module, then the barcode is a barcode that is placed on a piece of consumable, and process 3000 proceeds to step 3012. At 3012, a number of attributes are checked, including the color code, lot number, part number, expiration date, and the like. At step 3014, it is determined whether any of the attributes indicate an error. If there is any error, then the error is reported at step 3016, and process 3000 proceeds to step 3018; otherwise, process 3000 proceeds to step 3018. At step 3018, it is determined whether there is another barcode to decode. If there is another barcode to decode, then process 3000 proceeds to step 3008; otherwise, process 3000 is completed and terminated at 3020.

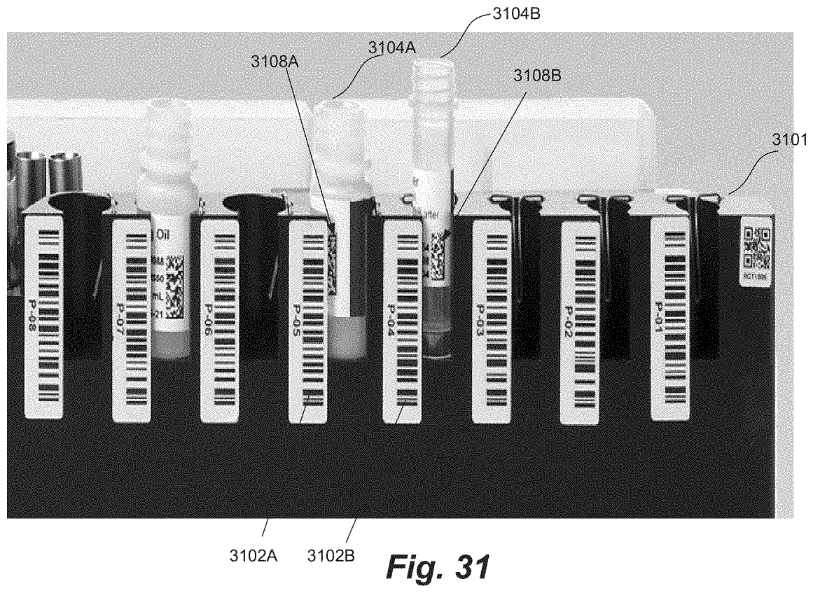

FIG. 31 illustrates another embodiment in which barcodes are placed on a deck module 3101 and the consumables 3104A and 3104B that are loaded onto the module. Deck module 3101 is a module for holding a plurality of tubes (e.g., tubes 3104A and 3104B). Each of the slots for holding the tubes is labeled with a barcode (e.g., barcodes 3102A and 3102B), and each of the tubes inserted into the slots is labeled with its barcode (e.g., barcodes 3108A and 3108B). Consumable tracking and error detection system 2400 may read the barcode corresponding to a slot and the barcode corresponding to the tube inserted into the slot, which are adjacent to each other, and determine whether the two barcodes are compatible with each other. For example, the information decoded from the barcodes may be used to check the part numbers, lot number, and expiration date.

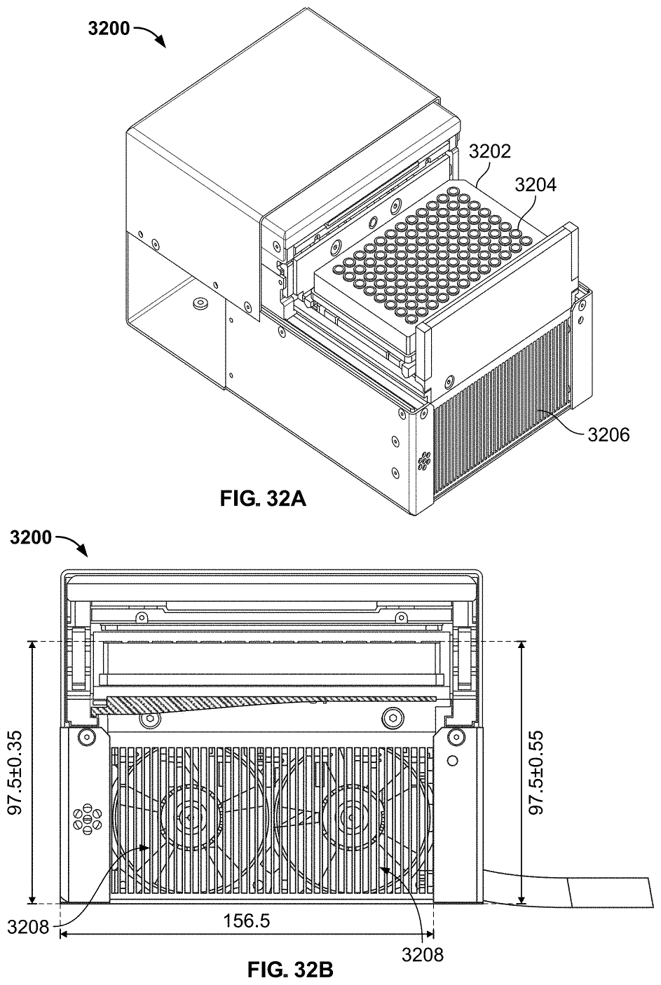

An automated library generator may include components that generate heat, thereby creating heat spots within the system. For example, automated library generator 200 may include an on-deck thermal cycler 224 (ODTC), as shown in FIG. 2. FIGS. 32A and 32B illustrate two additional views of one embodiment of a thermal cycler 3200. Thermal cyclers may be used to amplify segments of Deoxyribonucleic acid (DNA) via the polymerase chain reaction (PCR). Thermal cyclers may also be used to facilitate other temperature-sensitive reactions. As shown in FIG. 32, thermal cycler 3200 has a thermal block 3202 with holes 3204 where tubes holding reaction mixtures may be inserted. Thermal cycler 3200 then raises and lowers the temperature of the block 3202 in discrete, pre-programmed steps. Thermal cycler 3200 includes one or more heat sinks 3206 and fans 3208 for removing the heat from the elements and improving the efficiency of the system. However, heat may still accumulate around thermal cycler 3200 and the deck components that are close to the thermal cycler.

In the present application, an air flow system for an automated library generator is disclosed. Air flow is created by the air flow system to eliminate hot spots within the automated library generator. The system includes an instrument deck having an instrument deck floor, wherein the instrument deck is configured to receive a plurality of deck modules or consumables. The instrument deck is enclosed by a frame. A first fan is mounted on the frame enclosing the instrument deck. A first air vent within the frame provides an opening to an air duct below the instrument deck floor. A second air vent on an outer surface of the frame provides an opening to the air duct.

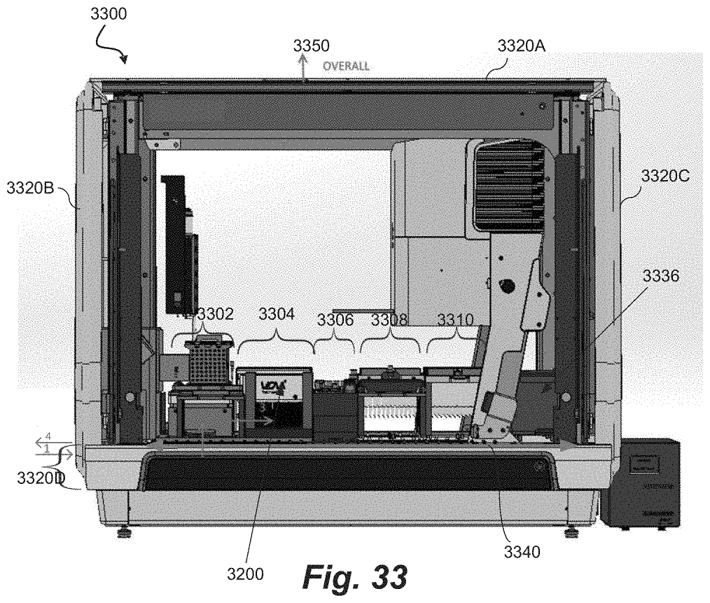

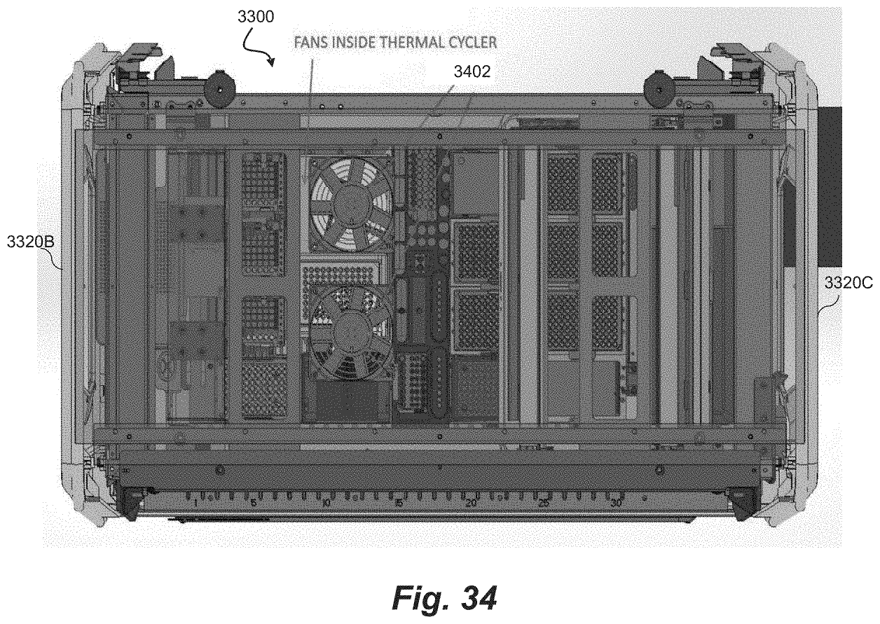

FIGS. 33 and 34 illustrate two different views of an exemplary configuration of an automated library generator 3300 in which airflow is created to eliminate hot spots within the system. FIG. 33 illustrates a front view of the automated library generator 3300. FIG. 34 illustrates a top view of the automated library generator 3300.

As shown in FIG. 33, automated library generator 3300 includes a frame 3320 housing the system 3300. The frame 3320 includes a top horizontal frame 3320A, a left vertical side frame 3320B, a right vertical side frame 3320C, and a bottom base frame 3320D. A deck floor 3340 is located above the bottom base frame 3320D. Automated library generator 3300 includes five carriers (3302, 3304, 3306, 3308, and 3310) and a disposal bin 3336 above the deck floor 3340. Thermal cycler 3200 is located in carrier 3304.

As shown in FIG. 34, automated library generator 3300 includes two top fans 3402 mounted on the top horizontal frame 3320A. The top fans 3402 are placed above the deck floor 3340 and the carriers (3302, 3304, 3306, 3308, and 3310).

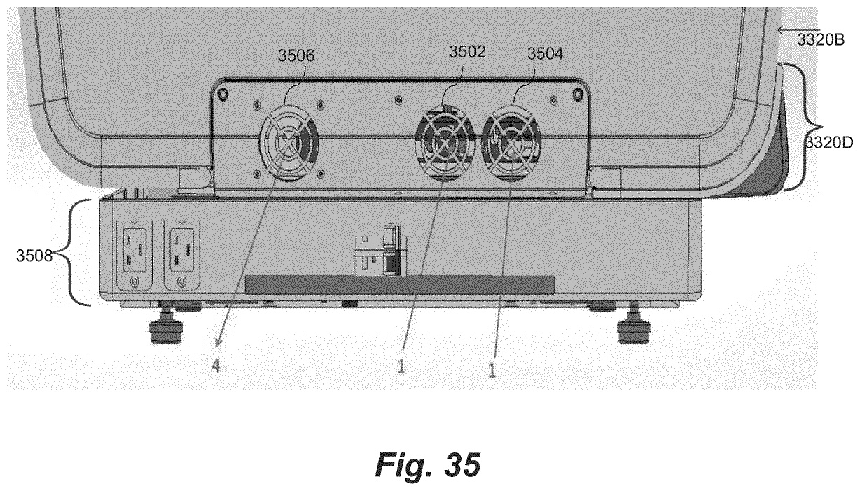

FIG. 35 illustrates a view showing a portion of the left vertical side frame 3320B, the bottom base frame 3320D, and an integrated communication and power base compartment of automated library generator 3300. A plurality of air vents (3502, 3504, and 3506) is located on the outside surface of the bottom base frame 3320D. FIG. 35 illustrates that cold air is brought into the bottom base frame 3320D through air vents 3502 and 3504, as indicated by arrows 1, and hot air is brought out of the bottom base frame 3320D through air vent 3506 as indicated by arrow 4.

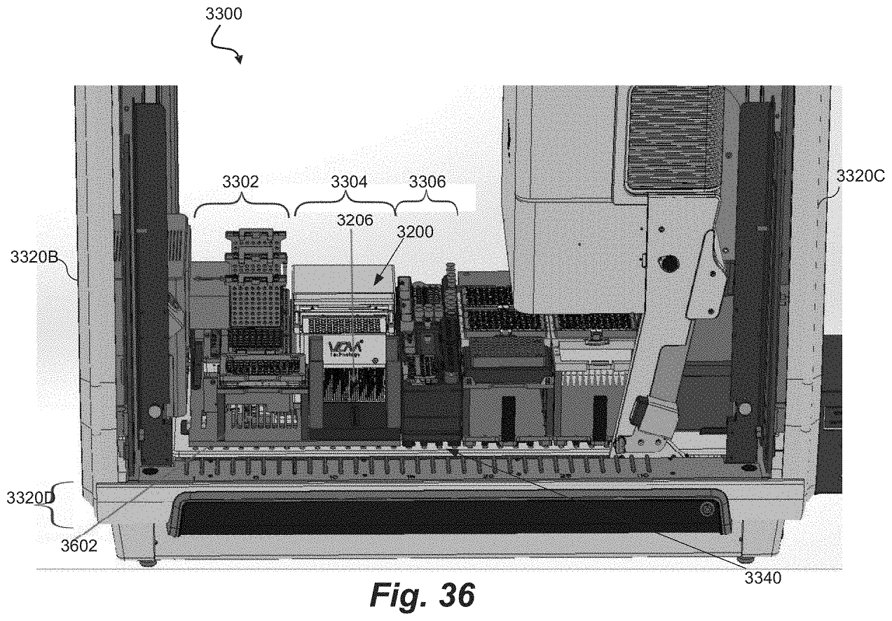

FIG. 36 illustrates yet another view of automated library generator 3300. As shown in FIG. 36, air vents 3602 are located within the frame and at the base of carrier 3302. The air vents 3602 are openings to air ducts below the deck floor 3340, as will be described in greater detail below. In some other embodiments, air vents may also be placed at the base of carrier 3304 or at the bases of other carriers (e.g., carrier 3306) adjacent to carrier 3304. The air vents are also shown in FIG. 2 and FIG. 3 as air vents 244 and 338, respectively. The heat sink is also shown in FIG. 2 and FIG. 3 as heat sinks 246 and 342, respectively.

As shown in FIG. 33, the top fans 3402 (shown in FIG. 34) blow air out of the frame 3320 in an upward overall direction 3350. The top fans 3402 create a negative pressure in the enclosure within the frame 3320, which brings air into the frame 3320 through air vents 3502 and 3504 on the bottom base frame 3320D as indicated by the arrows 1 in FIG. 33 and FIG. 35, respectively. The air vents (3502 and 3504) on the bottom base frame 3320D are connected to a plurality of air ducts that are placed in the bottom base frame 3320D and below deck floor 3340 and at least some of the carriers ((3302, 3304, 3306, 3308, and 3310). As shown in FIG. 33, cold air first flows horizontally in a direction as indicated by arrow 1 through the horizontal portions of the air ducts, and then the cold air flows upwards through the vertical portions of the air ducts and through the vents 3602 (see FIG. 36) located at the base of carrier 3302 as indicated by arrow 2. The cold air is then directed to cool the internal components of the system as indicated by arrow 3. For example, one or more fans 3208 in the thermal cycler 3200 may be used to create a forced convection that draws the cold air to the thermal cycler 3200 and its heat sink 3206 (as indicated by arrow 3) to cool down the thermal cycler 3200 and its heat sink 3206. The hot air is then directed out of the frame 3300 through air vent 3506 on the bottom base frame 3320D as indicated by arrow 4 in FIG. 33 and FIG. 35, respectively. For example, the hot air enters the vents 3602 and flows downwards through the vertical portions of the air ducts. The hot air then flows horizontally through the horizontal portions of the air ducts and then exits the frame via air vent 3506.

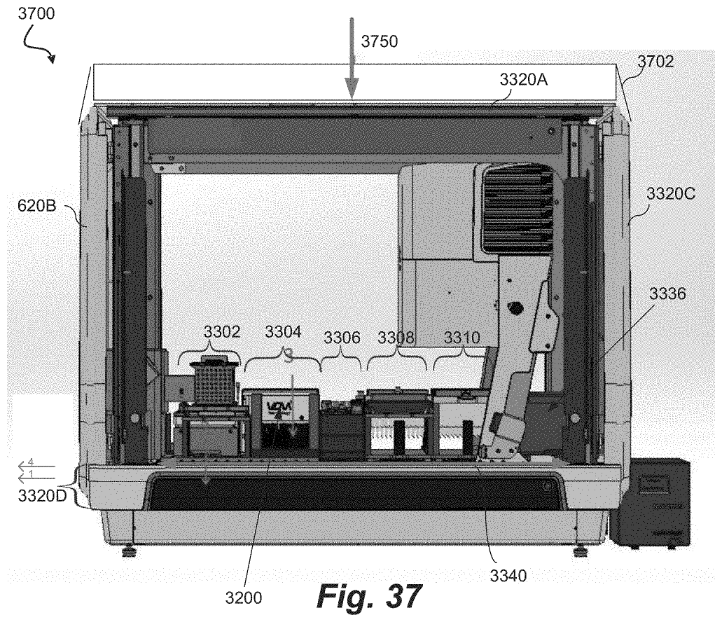

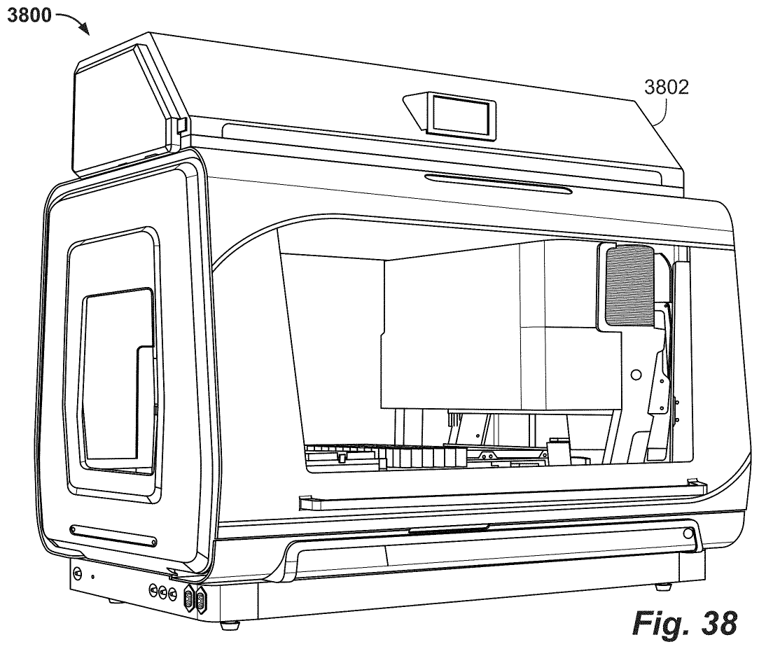

FIG. 37 illustrates another exemplary configuration of an automated library generator 3700 in which airflow is created to eliminate hot spots within the system. Automated library generator 3700 is similar to automated library generator 3300 described above. One difference between automated library generator 3700 and automated library generator 3300 is that automated library generator 3700 has one or more top fans plus a HEPA (high-efficiency particulate air) filter 3702 placed above the top horizontal frame 3320A. FIG. 38 illustrates another embodiment of an automated library generator 3800 with a HEPA filter hood 3802.

As shown in FIG. 37, the top fans blow cold air into the frame 3320 in a downward overall direction 3750. The cold air is then directed to cool the internal components of the system as indicated by arrow 3. For example, one or more fans 3208 in the thermal cycler 3200 may be used to create a forced convection that draws the cold air to the thermal cycler 3200 and its heat sink 3206 (as indicated by arrow 3) to cool down the thermal cycler 3200 and its heat sink 3206. As shown in FIG. 37, the hot air then flows downwards through the vents 3602 located at the base of carrier 3302 and through the vertical portions of the air ducts, as indicated by arrow 2. The air vents (3502, 3504, and 3506) on the bottom base frame 3320D are connected to the plurality of air ducts that are placed in the bottom base frame 3320D and below deck floor 3340 and at least some of the carriers ((3302, 3304, 3306, 3308, and 3310). The hot air then flows horizontally in a direction as indicated by arrow 1 and arrow 4 through the horizontal portions of the air ducts, and then the hot air flows out of the frame through the air vents (3502, 3504, and 3506) on the bottom base frame 3320D as indicated by arrows 1 and arrow 4.

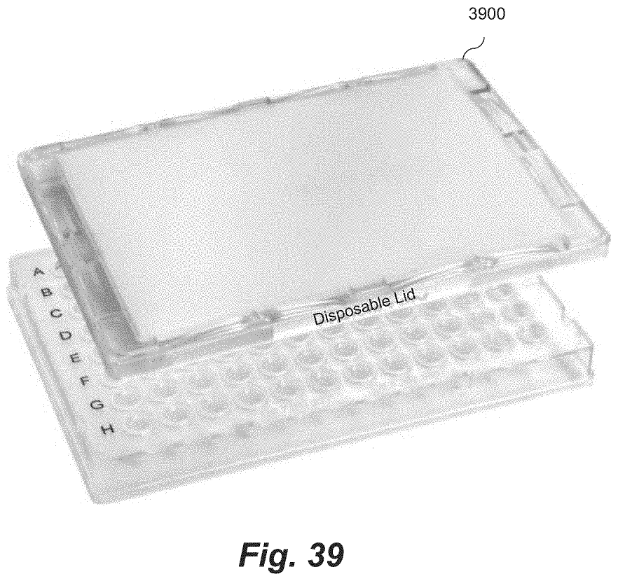

The thermal cycler may be used to heat the PCR reaction mixtures to very high temperatures. As a result, the PCR reaction mixtures may evaporate, thereby causing unreliable PCR results. In addition, the PCR reaction mixtures may be contaminated during the thermos-cycling process. Therefore, in some embodiments, sealing lids may be used to cover the wells of a PCR plate during thermo-cycling to reduce evaporation and contamination of the reaction mixtures. FIG. 39 illustrates a disposable PCR lid 3900.

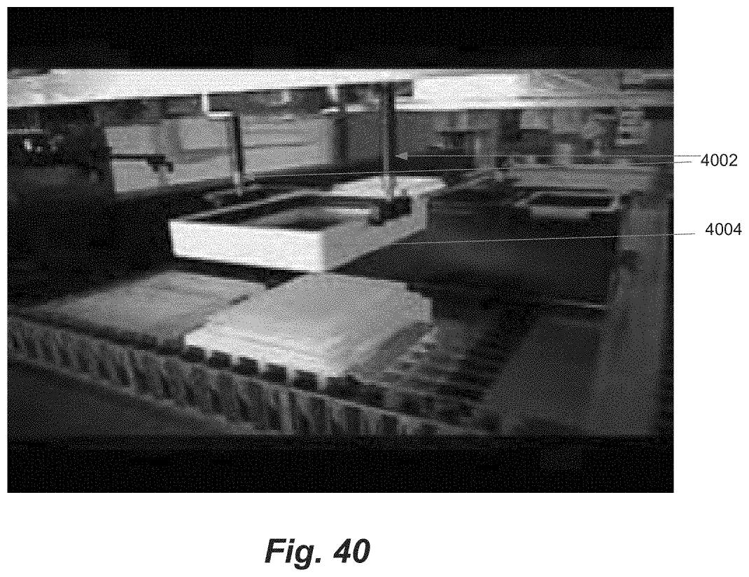

A disposable PCR lid 3900 may be picked up by a core gripper controlled by a movable gantry. FIG. 40 illustrates a core gripper 4002 lifting a piece of labware 4004 up and moving the piece of labware 4004 to another position within the deck. The core gripper 4002 may be programmed to lift a disposable PCR lid 3900 from rack 226 (see FIG. 2) for storing lids and place the disposable PCR lid 3900 to seal a PCR plate that has been loaded onto the thermal cycler. After the thermos-cycling process, the core gripper 4002 may further be programmed to unseal the PCR plate by lifting the disposable PCR lid 3900 up. The core gripper 4002 may then be programmed to move the disposable PCR lid 3900 over a waste disposal bin (236, 336, or 3336) and drop the lid into the waste disposal bin.

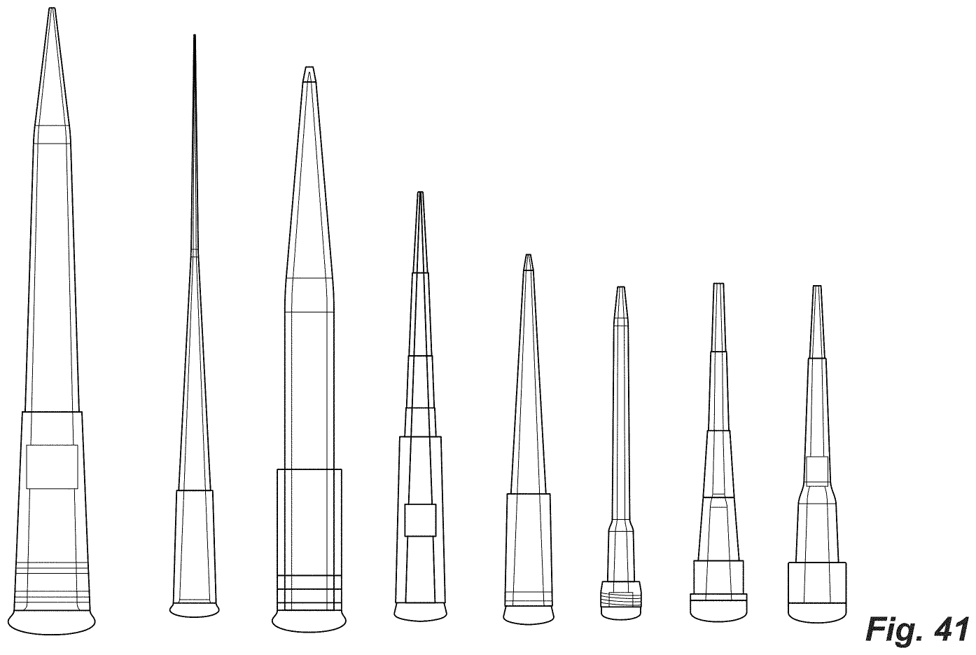

In additional to storing the disposal PCR lids, the waste disposal bin is also used to store recycled tips. FIG. 41 illustrates a plurality of disposable tips that may be attached to the pipetting head. The pipetting head (e.g., the multi-channel pipetting head 402 shown in FIG. 4) may be programmed to move to the waste disposal bin and drop the disposable tips into the waste disposal bin. However, when both the disposal PCR lids and the recycled tips are disposed in the same waste disposal bin, the disposal PCR lids tend to stack up and topple over, causing contamination and system malfunctioning. Therefore, improved techniques of storing recycled tips and lids would be desirable.

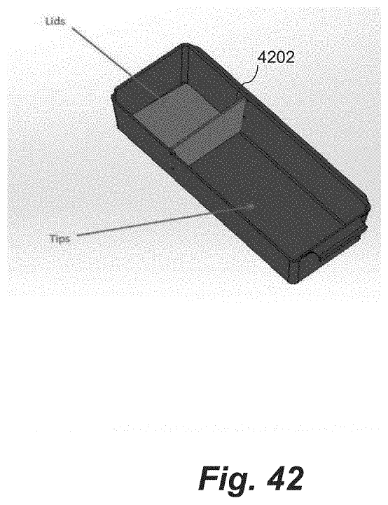

The automated library generator may alleviate the above problems by disposing the recycled tips and lids into different sections of the waste disposal bin. In some embodiments, a divider may be added to the waste disposal bin for separating the recycled tips and lids. FIG. 42 illustrates that with the added divider 4202, one side of the waste disposal bin is used for storing the tips and the other side of the waste disposal bin is used for storing the lids. One advantage is that it prevents the lids from stacking up and toppling over, thereby reducing system malfunctioning. Another advantage is that it allows the recycling of the tips and the lids while preventing contamination.

The gantry may be programmed to translate the pipetting head to a set of x and y positions, wherein the x and y positions are measured in a plane substantially parallel to a floor of an instrument deck. The x and y positions are determined as the x and y positions corresponding to the portion of the waste disposal bin for storing disposable tips. For example, the x and y positions are determined as the x and y positions of the pipetting head such that when the pipetting head is controlled to drop the disposable tips, the disposable tips are deposited on the portion of the waste disposal bin for storing tips.

The gantry may be programmed to translate the core gripper to a set of x and y positions, wherein the x and y positions are measured in a plane substantially parallel to a floor of an instrument deck. The x and y positions are determined as the x and y positions corresponding to the portion of the waste disposal bin for storing disposable lids. For example, the x and y positions are determined as the x and y positions of the core gripper such that when the core gripper is controlled to release the disposable lids, the disposable lids are deposited on the portion of the waste disposal bin for storing the disposable lids.

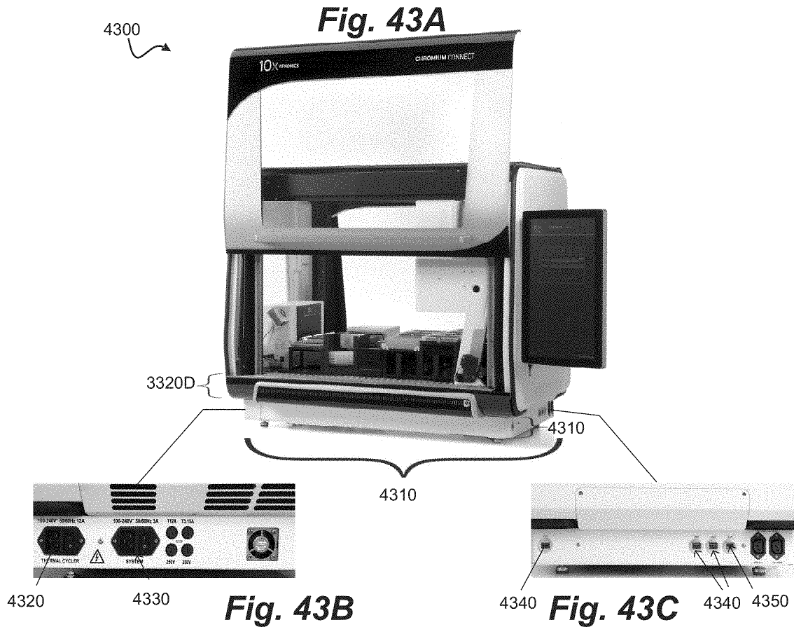

An automated library generator may include an integrated communication and power base compartment. FIG. 43A illustrates a view of an automated library generator 4300 that includes an integrated communication and power base compartment 4310. FIG. 43B and FIG. 43C each illustrates a view of the integrated communication and power base compartment 4310. The integrated communication and power base compartment 4310 integrates a plurality of power and communication components at the base of the system by enclosing the components in a compartment below the bottom base frame 3320D. The integrated communication and power base compartment 4310 provides a clean design and ensures electric safety by eliminating the use of external power strips and external boxes/modules to provide power and connectivity to the automatic library generator.

As shown in FIG. 43B, compartment 4310 includes a separate power plug/socket 4320 for powering the thermal cycler and another power plug/socket 4330 for powering the entire system. Each of the power plug/socket has its own switch to turn the power on or off. The switch for the entire system may be used to turn on the entire system, such that all components are up and running.

As shown in FIG. 43C, compartment 4310 further includes a plurality of USB (Universal Serial Bus) receptacles 4340 for providing connection, communication, and power between the automatic library generator and other computers or peripherals. Compartment 4310 further includes a LAN (Local Area Networks) port 4350, which allows the automatic library generator to be connected with other client machines, server machines and network devices via the LAN port.

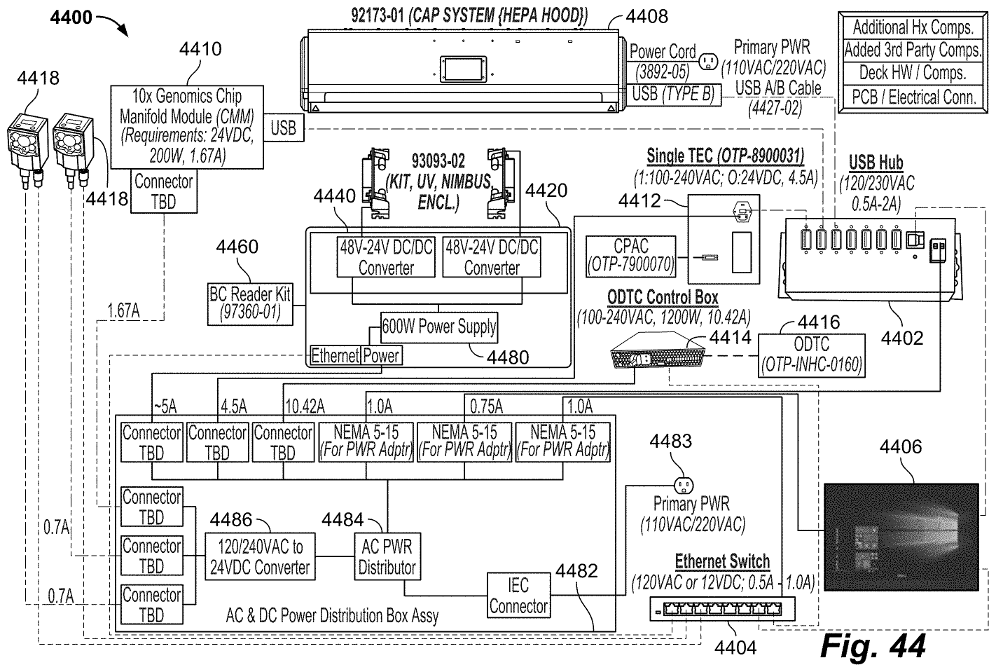

FIG. 44 illustrates an exemplary schematic diagram 4400 showing the connections of the integrated communication and power base compartment with other components of the automatic library generator. The integrated communication and power base compartment encloses at least one USB hub 4402, Ethernet switch 4404, and other ports for data transfer. USB hub 4402 provides USB connections to computers or peripherals, such as a tablet/touch screen computer 4406, a HEPA filter hood 4408, a chip manifold module 4410 (CMM), and a cold plate controller (CPAC) 4412. Ethernet switch 4404 provides communication of devices through a local area network (LAN). The devices connected to the LAN may include an on-deck thermal cycler controller (ODTC) 4414 that controls the ODTC 4416. Another device connected to the LAN is the tablet/touch screen computer 4406. Another device connected to the LAN is a pair of barcode scanners 4418. Another device connected to the LAN is a module 4420 that includes multiple components, including a module 4440 with two DC-DC converters, a barcode reader kit 4460, and a power supply 4480.

The integrated communication and power base compartment encloses an alternating current (AC) & direct current (DC) power distribution module 4482. AC and DC power distribution module 4482 may be connected to a primary power source 4483. Module 4482 includes an AC power distributor 4484 that distributes AC power to various components of the automatic library generator, including Ethernet switch 4404, tablet/touch screen computer 4406, USB hub 4402, on-deck thermal cycler controller (ODTC) 4414, cold plate controller 4412, and module 4420. Module 4482 includes an AC to DC converter 4486 that distributes DC power to various components of the automatic library generator, including the pair of barcode scanners 4418, and the chip manifold module 4410.

Magnetic separator plate 214 in FIG. 2 performs magnetic bead based cleanup. Magnetic beads are used for DNA purification and fragment size selection. Automated single cell sequencing system 200 uses the single-cell RNA-seq technology to analyze transcriptomes on a cell-by-cell basis through the use of microfluidic partitioning to capture single cells and prepare barcoded, next-generation sequencing (NGS) cDNA libraries. Specifically, single cells, reverse transcription (RT) reagents, gel beads containing barcoded oligonucleotides, and oil are combined on a microfluidic chip to form reaction vesicles called Gel Beads in Emulsion, or GEMs. After incubation, GEMs are broken and pooled fractions are recovered. Silane magnetic beads are used to purify the first-strand cDNA from the post GEM-RT reaction mixture, which includes leftover biochemical reagents and primers. In particular, consumables (e.g., test tubes or wells) containing the post GEM-RT reaction mixture and the magnetic beads may be loaded onto the magnetic separator plate 214 where the magnetic bead based cleanup is performed. Barcoded, full-length cDNA is then amplified via PCR to generate sufficient mass for library construction.

FIG. 7A illustrates a top view of an embodiment of a magnetic separator plate 702. FIG. 7B illustrates a cross sectional view of the magnetic separator plate 702. FIG. 7C illustrates another view of the magnetic separator plate 702.

As shown in FIG. 7A, magnetic separator plate 702 is a magnet holder plate that holds an array of magnets 704. Magnetic separator plate 702 is a 96-ring magnet plate, and the array of magnets 704 is an 8×12 array of magnets with eight magnets in a row and twelve magnets in a column. In some embodiments, each of the magnets 704 is a ring magnet. As shown in FIG. 7B, a ring magnet may be a magnet with a shape of a hollow cylinder that is empty from inside and with differing internal and external radii. The hollow space of the cylinder allows a bottom end of a tube to be inserted therein. For example, a tube received by a ring magnet may be a finger-like length of glass or plastic tubing that is open at the top and closed at the bottom.

FIG. 25 illustrates a plurality of strip tubes 2502 that may be loaded onto the magnetic separator plate 214 or magnetic separator plate 702 where the magnetic bead based cleanup may be performed. As shown in FIG. 25, each of the strip tubes 2502 includes eight tubes 2504 for storing the reaction mixture and the magnetic beads.

FIG. 8 illustrates an exemplary consumable 802 that may be loaded onto the magnetic separator plate 214 or magnetic separator plate 702 where the magnetic bead based cleanup may be performed. In this example, consumable 802 is a 96-tube polymerase chain reaction (PCR) tube holder plate with an array of tubes 804 arranged as an 8×12 array of tubes with eight tubes in a row and twelve tubes in a column.

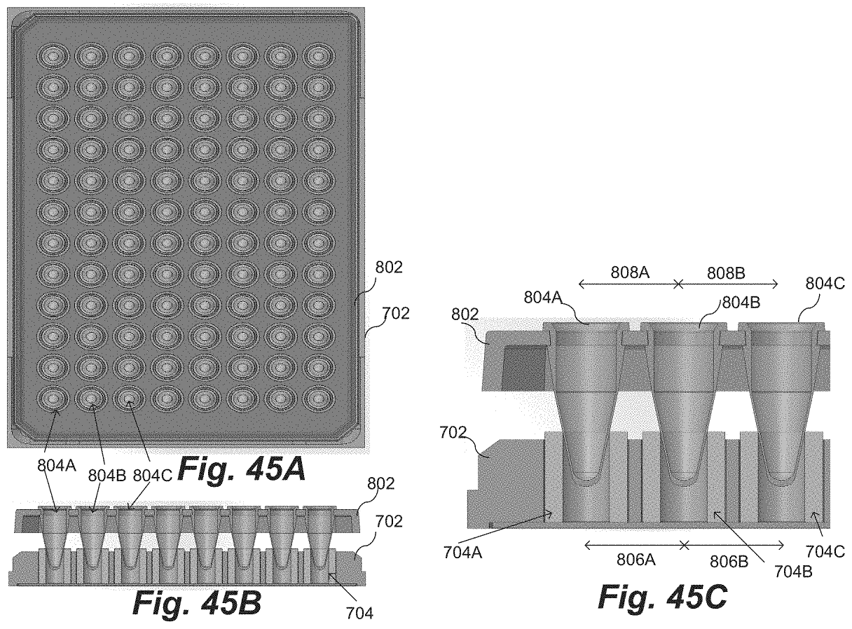

FIG. 45A illustrates a top view of the 96-tube PCR plate 802 being loaded onto the magnetic separator plate 702. FIG. 45B illustrates a cross sectional view of the 96-tube PCR plate 802 being loaded onto the magnetic separator plate 702. FIG. 45C illustrates a portion of a magnified cross-sectional view of the 96-tube PCR plate 802 being loaded onto the magnetic separator plate 702.

As shown in FIGS. 45B and 45C, the hollow space of a ring magnet (e.g., 704A or 704B) allows the bottom end of a tube (e.g., 804A or 804B) to be inserted therein. However, both the PCR plate 802 and the magnetic separator plate 702 are manufactured parts that have their respective sets of associated tolerances. All dimensions of a manufactured part have their associated tolerance, the amount that the particular dimension is allowed to vary. The tolerance is the difference between the maximum and minimum limits. Therefore, the length 806A (the length from the center of the ring magnet 704A to the center of the ring magnet 704B) and the length 806B (the length from the center of the ring magnet 704B to the center of the ring magnet 704C) may not be the same. Similarly, the length 808A (the length from the center of the tube 804A to the center of the tube 804B) and the length 808B (the length from the center of the tube 808B to the center of the tube 804C) may not be the same. These variations in dimensions may cause misalignments of the tubes and their corresponding ring magnets. As a result, some of the bottom ends of the tubes may no longer be inserted into the hollow spaces and resting within the hollow spaces of the ring magnets at the same depth, causing the PCR plate 802 to be tilted instead of leveled, and causing it to rest on the magnetic separator plate 702 at an angle, thereby degrading the performance of the magnetic bead based cleanup process.

In the present application, an improved magnetic separator is disclosed. The magnetic separator comprises an array of magnets configured to interact with an array of tubes, wherein the array of tubes is attached to a plate. The magnetic separator further includes a magnetic separator plate adapter. In some embodiments, the adapter comprises a raised frame extending around a periphery of the array of magnets such that the raised frame is configured to support the plate, such that the array of tubes are suspended above the array of magnets. By suspending the array of tubes above the array of magnets, the bottom ends of the tubes are no longer resting within the hollow spaces of the ring magnets at different depths, thereby keeping the plate with the array of tubes leveled with respect to the array of magnets. The benefit is that the performance of the magnetic bead based cleanup process may be significantly improved.

FIG. 9A illustrates a top view of a magnetic separator plate adapter 902. FIG. 9B illustrates a cross sectional view of the magnetic separator plate adapter 902. FIG. 9C illustrates a bottom view of the magnetic separator plate adapter 902. FIG. 9D illustrates another view of the top surface of the magnetic separator plate adapter 902. FIG. 9E illustrates another view of the bottom surface of the magnetic separator plate adapter 902. As shown in FIG. 9A, magnetic separator plate adapter 902 includes four collars 904 at the four corners of the adapter. The collars 904 may be used to fix the location (the x and y location on the deck) of a consumable, such as a 96-tube PCR plate. For example, each of the collars 904 constrains the x location and the y location of the tube holder plate by having a tube inserted into the collar. The magnetic separator plate adapter 902 further includes four cylindrical feet 906 at the four corners of the adapter, such that the magnetic separator plate adapter 902 may be mounted on the magnetic separator plate 702. In some embodiments, magnetic separator plate adapter 902 may be formed of plastic and includes skirts. Magnetic separator plate adapter 902 may include a plurality of calibration posts 908.

FIG. 11A illustrates a top view of the magnetic separator plate adapter 902 being loaded onto the magnetic separator plate 702. FIG. 11B illustrates a cross sectional view of the magnetic separator plate adapter 902 being loaded onto the magnetic separator plate 702. FIG. 11C illustrates another cross sectional view of the magnetic separator plate adapter 902 being loaded onto the magnetic separator plate 702. FIG. 11D illustrates a portion of a magnified cross sectional view of the magnetic separator plate adapter 902 being loaded onto the magnetic separator plate 702. As shown in FIGS. 11B, 11C, and 11D, a cylindrical foot 906 of the magnetic separator plate adapter 902 fits into a cylindrical hole on the magnetic separator plate 702, thereby mounting the magnetic separator plate adapter 902 on the magnetic separator plate 702 and raising the magnetic separator plate adapter 902 above the magnetic separator plate 702.

FIG. 12A illustrates a view of the magnetic separator plate adapter 902 about to be loaded onto the magnetic separator plate 702 and the 96-tube PCR plate 802 about to be loaded onto the magnetic separator plate adapter 902. FIG. 12B illustrates another view of the magnetic separator plate adapter 902 being loaded onto the magnetic separator plate 702 and the 96-tube PCR plate 802 being loaded onto the magnetic separator plate adapter 902.

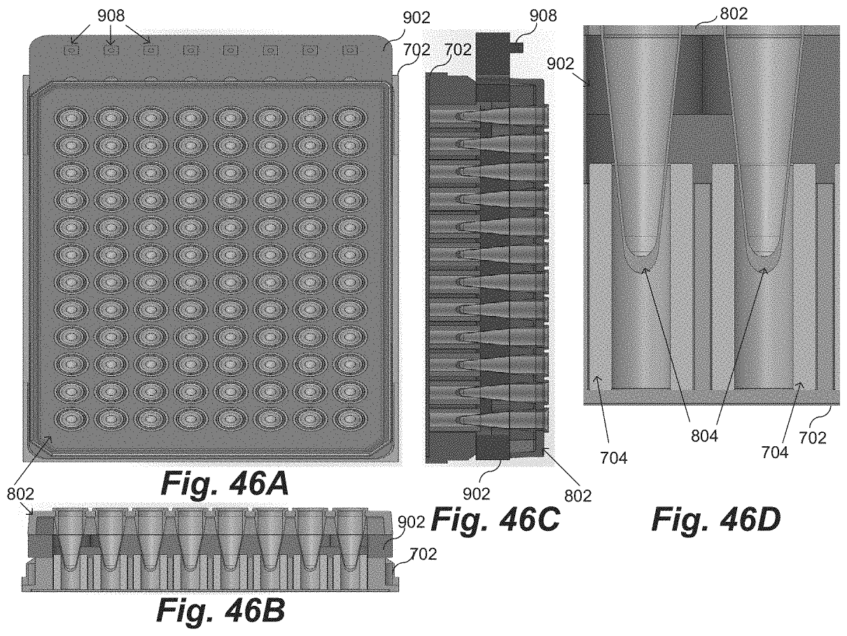

FIG. 46A illustrates a top view of the magnetic separator plate adapter 902 being loaded onto the magnetic separator plate 702, and the 96-tube PCR plate 802 being loaded onto the magnetic separator plate adapter 902. FIG. 46B illustrates a cross-sectional view of the magnetic separator plate adapter 902 being loaded onto the magnetic separator plate 702, and the 96-tube PCR plate 802 being loaded onto the magnetic separator plate adapter 902. FIG. 46C illustrates another cross-sectional view of the magnetic separator plate adapter 902 being loaded onto the magnetic separator plate 702, and the 96-tube PCR plate 802 being loaded onto the magnetic separator plate adapter 902. FIG. 46D illustrates a portion of a magnified cross-sectional view of the magnetic separator plate adapter 902 being loaded onto the magnetic separator plate 702, and the 96-tube PCR plate 802 being loaded onto the magnetic separator plate adapter 902.

The magnetic separator plate adapter 902 comprises a raised frame extending around the periphery of the magnetic separator plate 702, such that the raised frame supports the 96-tube PCR plate 802 in such a way that the array of tubes 804 are suspended above the array of magnets 704. As shown in FIG. 46D, the array of tubes is suspended above the array of magnets 704 at a height such that the tubes 804 do not come in contact with their corresponding magnets 704. By suspending the array of tubes 804 above the array of magnets 704, the bottom ends of the tubes 804 are no longer resting within the hollow spaces of the ring magnets at different depths, thereby keeping the 96-tube PCR plate 802 with the array of tubes 804 leveled with respect to the array of magnets 704. The benefit is that the performance of the magnetic bead based cleanup process may be significantly improved.

Although the foregoing embodiments have been described in some detail for purposes of clarity of understanding, the invention is not limited to the details provided. There are many alternative ways of implementing the invention. The disclosed embodiments are illustrative and not restrictive.

1. A calibration device, comprising:
an array of teaching pendants;
a translation actuator configured to translate the array of teaching pendants to a set of x and y positions, wherein the x and y positions are measured in a plane substantially parallel to a floor of an instrument deck;
a plurality of height actuators configured to move each of the teaching pendants in a direction substantially perpendicular to the plane; and
wherein one or more of the teaching pendants contact one or more teaching objects of an array of teaching objects above the instrument deck as a result of a position of the array of teaching pendants.

2. The calibration device of claim 1, wherein the array of teaching pendants is coupled to a multi-channel pipetting head of a liquid handling gantry.

3. The calibration device of claim 2, wherein the device is configured to calibrate the liquid is handling gantry based on results of the one or more of the teaching pendants contacting the one or more of the teaching objects.

4. The calibration device of claim 1, wherein a teaching pendant of the teaching pendants comprises a portion that is coupled to a pipetting head of a liquid handling gantry.

5. The calibration device of claim 1, wherein a teaching pendant of the teaching pendants tapers to a tip for contacting and detecting a teaching object.

6. The calibration device of claim 1, further comprising circuitries that are configured to detect a surface in response to a teaching pendant being substantially in contact with the surface.

7. The calibration device of claim 6, wherein the circuitries are configured to detect the surface in response to the teaching pendant being substantially in contact with the surface based on measurements of a combination of capacitance and conductivity.

8. The calibration device of claim 6, wherein the circuitries are configured to detect the surface in response to the teaching pendant being substantially in contact with the surface based on measurements of a combination of pressure and capacitance.

9. The calibration device of claim 6, wherein the circuitries are configured to detect the surface in response to the teaching pendant being substantially in contact with the surface based on measurements of a torque associated with a height actuator associated with the teaching pendant.

10. The calibration device of claim 6, wherein the circuitries are configured to detect the surface in response to the teaching pendant being substantially in contact with the surface based on measurements of a current driving a height actuator associated with the teaching pendant.

11. The calibration device of claim 6, wherein the circuitries are further configured to control a height actuator associated with the teaching pendant being substantially in contact with the surface, wherein the height actuator is controlled by the circuitries to stop the teaching pendant from further moving in the direction substantially perpendicular to the plane in response to the detection of the surface.

12. The calibration device of claim 6, wherein the set of x and y positions comprises a set of reference positions corresponding to the array of teaching objects or a set of x and y positions is having predetermined offsets from the set of reference positions corresponding to the array of teaching objects, wherein the array of teaching objects is associated with a deck module that is placed on or above the instrument deck.

13. The calibration device of claim 12, wherein the plurality of height actuators are configured to move each of the teaching pendants in the direction substantially perpendicular to the plane in response to the array of teaching pendants being translated to the set of x and y positions.

14. The calibration device of claim 13, wherein the device is further configured to determine a position of the teaching pendant measured along the direction substantially perpendicular to the plane in response to the detection of the surface.

15. The calibration device of claim 14, wherein the device is further configured to determine whether a teaching object is detected based on the determined position measured along the direction substantially perpendicular to the plane.

16. The calibration device of claim 15, wherein the teaching object comprises a teaching post standing on a floor surface.

17. The calibration device of claim 16, wherein surfaces detectable by the calibration device comprise a top surface of the teaching post and a top surface of the floor surface.

18. The calibration device of claim 15, wherein the teaching object comprises a well.

19. The calibration device of claim 18, wherein surfaces detectable by the calibration device comprise a top inner surface of the well and a top surface surrounding the well.

20. A method of calibrating a device, comprising:
translating an array of teaching pendants to a region where an array of teaching objects is located;
detecting a plurality of translation positions at which at least one pendant in the array of teaching pendants contacts a teaching object of the array of teaching objects; and
determining an adjustment offset based on the detected translation positions.

21. The method of claim 20, further comprising:
translating the array of teaching pendants to a set of reference positions corresponding to the array of teaching objects, wherein the array of teaching objects is associated with a deck module that is placed on or above an instrument deck.

22. The method of claim 21, further comprising:
lowering the array of teaching pendants in response to the array of teaching pendants being translated to the set of reference positions corresponding to the array of teaching objects.

23. The method of claim 22, further comprising:
detecting a surface in response to a teaching pendant being substantially in contact with the surface.

24. The method of claim 23, further comprising:
determining a height of the teaching pendant in response to the detection of the surface.

25. The method of claim 24, further comprising:
detecting a teaching object based on the determined height of the teaching pendant.

26. The method of claim 25, wherein a teaching object of the array of teaching objects comprises a teaching post standing on a floor surface, wherein the method further comprises:
detecting the teaching post based on a comparison between the determined height of the teaching pendant and a predetermined height based on a height of a top surface of the teaching post.

27. The method of claim 25, wherein a teaching object of the array of teaching objects comprises a well, wherein the method further comprises:
detecting the well based on a comparison between the determined height of the teaching pendant and a predetermined height based on a height of a top surface surrounding the well.

28. The method of claim 25, further comprising:
determining whether each of the teaching objects is detected.

29. The method of claim 25, further comprising:
verifying that the array of teaching pendants detects the array of teaching objects after the array of teaching pendants has been translated by a predetermined distance from the set of reference positions corresponding to the array of teaching objects and after the array of teaching pendants has been lowered toward the instrument deck.

30. The method of claim 29, wherein the translation of the array of teaching pendants by the predetermined distance comprises a translation in one of a plurality of directions.

31. The method of claim 25, further comprising:
determining a plurality of edges of each of the teaching objects, comprising determining positions of the plurality of edges.

32. The method of claim 31, further comprising:
determining a center point corresponding to each of the teaching objects based on the determined positions of the plurality of edges of each of the teaching objects.

33. The method of claim 32, further comprising:
for each of the teaching objects:
determining an offset from a reference position corresponding to the teaching object to the determined center point corresponding to the teaching object; and
determining an average offset based on the determined offsets corresponding to the array of teaching objects.

34. The method of claim 33, further comprising:
determining the adjustment offset based on the determined average offset, wherein the adjustment offset comprises an adjustment offset for calibrating a reference position corresponding to the deck module.

35. The method of claim 31, wherein determining one edge of a teaching object comprises:
translating the array of teaching pendants to the set of reference positions corresponding to the array of teaching objects;
in one direction, translating the array of teaching pendants by a predetermined distance in each step, until it is determined that a teaching pendant corresponding to the teaching object is no longer able to detect the teaching object when the teaching pendant is lowered towards the instrument deck;
determining a total distance translated in the one direction; and
determining the one edge of the teaching object based on the total distance translated in the one direction and a reference position corresponding to the teaching object.

36. The method of claim 35, further comprising:
determining a new reference position corresponding to each of the teaching objects based on the determined edges of each of the teaching objects.

37. The method of claim 36, further comprising:
for each of the teaching objects:
determining an offset from a reference position corresponding to the teaching object to the determined new reference position corresponding to the teaching object; and
determining an average offset based on the determined offsets corresponding to the array of teaching objects.

38. The method of claim 37, further comprising:
determining the adjustment offset based on the determined average offset, wherein the adjustment offset comprises an adjustment offset for calibrating a reference position corresponding to the deck module.

39. A system, comprising:
one or more barcode readers above an instrument deck;
one or more mirrors on the instrument deck; and
a processor;
wherein the one or more barcode readers are controlled by the processor to read a plurality of barcodes on a plurality of objects on the instrument deck through the one or more mirrors.

40. The system of claim 39, wherein unobstructed lines of sight between the barcode readers and the barcodes are not required.

41. The system of claim 39, wherein one of the plurality of barcodes readable by the one or more barcode readers is placed on a consumable, and wherein the barcode placed on the consumable encodes information that enables experiment tracking.

42. The system of claim 41, wherein the information that enables experiment tracking comprises one of the following: a part number, a lot number, a color code, and an expiration date.

43. The system of claim 41, wherein the barcode that is placed on the consumable is placed on a substantially vertical surface of the consumable.

44. The system of claim 41, wherein one of the plurality of barcodes readable by the one or more barcode readers is placed on a deck module, and wherein the consumable is loadable onto the deck module, and wherein the barcode placed on the deck module encodes information that enables experiment tracking.

45. The system of claim 44, wherein the information encoded in the barcode placed on the deck module comprises a type of module.

46. The system of claim 44, wherein the information encoded in the barcode placed on the deck module comprises one of the following: a slot number, a row number, and a column number within the deck module.

47. The system of claim 44, wherein the barcode placed on the deck module is placed on a substantially vertical surface of the deck module.

48. The system of claim 44, wherein the processor is configured to decode the barcode placed on the consumable and the barcode placed on the deck module, and the processor is further configured to determine whether the two barcodes are compatible with an experiment.

49. The system of claim 44, wherein the consumable being loaded onto the deck module covers the barcode placed on the deck module, and wherein the processor is configured to determine that a barcode read by the one or more barcode readers corresponds to the deck module and in response determine that the deck module is not loaded with the consumable.

50. The system of claim 49, wherein the processor is configured to determine that a barcode read by the one or more barcode readers corresponds to the consumable and in response determine that the deck module is loaded with the consumable, and the processor is further configured to decode the barcode placed on the consumable and determine whether the barcode is compatible with an experiment.

51. A method, comprising:
controlling by a processor one or more barcode readers above an instrument deck; and
receiving data by the processor from the one or more barcode readers;
wherein the one or more barcode readers are controlled by the processor to read a plurality of barcodes on a plurality of objects on the instrument deck through one or more mirrors, wherein the one or more mirrors are located on the instrument deck.

52. The method of claim 51, wherein unobstructed lines of sight between the barcode readers and the barcodes are not required.

53. The method of claim 51, wherein one of the plurality of barcodes readable by the one or more barcode readers is placed on a consumable, and wherein the barcode placed on the consumable encodes information that enables experiment tracking.

54. The method of claim 53, wherein the information that enables experiment tracking comprises one of the following: a part number, a lot number, a color code, and an expiration date.

55. The method of claim 53, wherein the barcode that is placed on the consumable is placed on a substantially vertical surface of the consumable.

56. The method of claim 53, wherein one of the plurality of barcodes readable by the one or more barcode readers is placed on a deck module, and wherein the consumable is loadable onto the deck module, and wherein the barcode placed on the deck module encodes information that enables experiment tracking.

57. The method of claim 56, wherein the information encoded in the barcode placed on the deck module comprises a type of module.

58. The method of claim 56, wherein the information encoded in the barcode placed on the deck module comprises one of the following: a slot number, a row number, and a column number within the deck module.

59. The method of claim 56, wherein the barcode placed on the deck module is placed on a substantially vertical surface of the deck module.

60. The method of claim 56, further comprising:
decoding by the processor the barcode placed on the consumable and the barcode placed on the deck module; and
determining by the processor whether the two barcodes are compatible with an experiment.

61. The method of claim 56, wherein the consumable being loaded onto the deck module covers the barcode placed on the deck module, and wherein the method further comprising:
determining that a barcode read by the one or more barcode readers corresponds to the deck module; and
in response, determining that the deck module is not loaded with the consumable.

62. The method of claim 61, further comprising:
determining that a barcode read by the one or more barcode readers corresponds to the consumable;
in response, determining that the deck module is loaded with the consumable;
decoding the barcode placed on the consumable; and
determining whether the barcode is compatible with an experiment.

63. A system, comprising:
an instrument deck having an instrument deck floor, wherein the instrument deck is configured to receive a plurality of deck modules or consumables;
a frame enclosing the instrument deck;
a first fan mounted on the frame enclosing the instrument deck;
a first air vent within the frame, the first air vent providing an opening to an air duct below the instrument deck floor; and
a second air vent on an outer surface of the frame, the second air vent providing an opening to the air duct.

64. The system of claim 63, wherein the first air vent is positioned at a portion of the instrument deck floor, wherein the instrument deck is configured to receive a deck module that generates heat, and wherein the portion of the instrument deck floor is at a base of the deck module or adjacent to the base of the deck module.

65. The system of claim 64, wherein the deck module comprises an on-deck thermal cycler.

66. The system of claim 64, wherein the first fan is mounted on a top portion of the frame, and wherein the first fan is positioned above the deck module that generates heat.

67. The system of claim 66, wherein the first fan is configured to blow air out of the frame in an upward direction that creates a negative air pressure in an enclosure within the frame.

68. The system of claim 67, wherein in response to the first fan being configured to blow air out of the frame in the upward direction that creates the negative air pressure in the enclosure within the frame, cold air is drawn into the frame via the second air vent on the outer surface of the frame, the air duct, and the first air vent within the frame.

69. The system of claim 68, wherein the cold air flows horizontally through a horizontal portion of the air duct, and the cold air flows upwards through a vertical portion of the air duct and enters the enclosure of the frame via the first air vent.

70. The system of claim 68, wherein a second fan within the frame is configured to create a forced convection that draws the cold air to cool the deck module.

71. The system of claim 70, further comprising a third air vent on the outer surface of the frame, wherein the third air vent provides an opening to the air duct, and wherein the cold air absorbs heat from the deck module and turns into hot air, wherein the hot air exits the frame via the first air vent within the frame, the air duct, and the third air vent.

72. The system of claim 64, further comprising a high-efficiency particulate air (HEPA) filter, wherein the HEPA filter and the first fan are mounted on a top portion of the frame, and wherein the HEPA filter and the first fan are positioned above the deck module that generates heat.

73. The system of claim 72, wherein the first fan is configured to blow cold air into an enclosure within the frame in a downward direction.

74. The system of claim 73, wherein a second fan within the frame is configured to create a forced convection that draws the cold air to cool the deck module.

75. The system of claim 74, wherein the cold air absorbs heat from the deck module and turns into hot air, and wherein the hot air exits the frame via the first air vent within the frame, the air duct, and the second air vent.

76. The system of claim 63, further comprising:
a waste disposal bin, the waste disposal bin having a first portion for storing disposable tips and a second portion for storing disposable lids;
a gantry configurable to translate a pipetting head to a first set of x and y positions, wherein the first set of x and y positions are measured in a plane substantially parallel to the instrument deck floor, and wherein when the pipetting head is controlled to drop a plurality of disposable tips at the set of x and y positions, the plurality of disposable tips being deposited on the first portion for storing disposable tips.

77. The system of claim 76, wherein the gantry is configurable to translate a core gripper to a second set of x and y positions, wherein the second set of x and y positions are measured in the plane substantially parallel to the instrument deck floor, and wherein when the core gripper is controlled to drop a disposable lid at the second set of x and y positions, the disposable lid being deposited on the second portion for storing disposable lids.

78. The system of claim 63, further comprising:
a communication and power base compartment below the frame enclosing the instrument deck, the communication and power base compartment enclosing a plurality of power and communication components.

79. The system of claim 78, wherein the plurality of power and communication components comprises one or more of the following: a USB hub, an Ethernet switch, and an alternating current (AC) & direct current (DC) power distribution module.

80. A method, comprising:
providing an instrument deck having an instrument deck floor, wherein the instrument deck is configured to receive a plurality of deck modules or consumables;
providing a frame enclosing the instrument deck;
providing a first fan mounted on the frame enclosing the instrument deck;
providing a first air vent within the frame, the first air vent providing an opening to an air duct below the instrument deck floor; and
providing a second air vent on an outer surface of the frame, the second air vent providing an opening to the air duct.

81. The method of claim 80, wherein the first air vent is positioned at a portion of the instrument deck floor, wherein the instrument deck is configured to receive a deck module that generates heat, and wherein the portion of the instrument deck floor is at a base of the deck module or adjacent to the base of the deck module.

82. The method of claim 80, further comprising:
providing a waste disposal bin, the waste disposal bin having a first portion for storing disposable tips and a second portion for storing disposable lids;
providing a gantry configurable to translate a pipetting head to a first set of x and y positions, wherein the first set of x and y positions are measured in a plane substantially parallel to the instrument deck floor, and wherein when the pipetting head is controlled to drop a plurality of disposable tips at the set of x and y positions, the plurality of disposable tips being deposited on the first portion for storing disposable tips.

83. The method of claim 82, wherein the gantry is configurable to translate a core gripper to a second set of x and y positions, wherein the second set of x and y positions are measured in the plane substantially parallel to the instrument deck floor, and wherein when the core gripper is controlled to drop a disposable lid at the second set of x and y positions, the disposable lid being deposited on the second portion for storing disposable lids.

84. The method of claim 80, further comprising:
providing a communication and power base compartment below the frame enclosing the instrument deck, the communication and power base compartment enclosing a plurality of power and communication components.

85. A magnetic separator, comprising:
an array of magnets configured to interact with a tube holder plate, wherein the tube holder plate comprises an array of tubes; and
a raised frame extending around a periphery of the array of magnets such that the raised frame is configured to support the tube holder plate such that the array of tubes is suspended above the array of magnets.

86. The magnetic separator of claim 85, wherein the array of tubes is suspended above the array of magnets at a height such that each tube does not come in contact with its corresponding magnet.

87. The magnetic separator of claim 85, wherein the array of magnets comprises an array of ring magnets, and wherein the array of tubes is suspended above the array of ring magnets such that the bottom ends of the tubes are not resting within the hollow spaces of the ring magnets at different depths.

88. The magnetic separator of claim 87, wherein the array of tubes is suspended above the array of ring magnets such that the tube holder plate is leveled with respect to the array of ring magnets.

89. The magnetic separator of claim 85, wherein the array of magnets are held by a magnet holder plate, and wherein the raised frame comprises a plurality of feet, wherein each foot fits into a corresponding hole on the magnet holder plate such that the raised frame is mounted on the magnet holder plate.

90. The magnetic separator of claim 89, wherein the raised frame is mounted on the magnet holder plate such that the raised frame is raised above the magnet holder plate.

91. The magnetic separator of claim 85, wherein the raised frame comprises a plurality of collars, wherein each of the collars constrains a x location and a y location of the tube holder plate.

92. The magnetic separator of claim 91, wherein each of the collars constrains the x location and the y location of the tube holder plate by having a tube inserted into the collar.

93. A method, comprising:
providing an array of magnets configured to interact with a tube holder plate, wherein the tube holder plate comprises an array of tubes; and
providing a raised frame extending around a periphery of the array of magnets such that the raised frame is configured to support the tube holder plate such that the array of tubes is suspended above the array of magnets.

94. The method of claim 93, wherein the array of tubes is suspended above the array of magnets at a height such that each tube does not come in contact with its corresponding magnet.

95. The method of claim 93, wherein the array of magnets comprises an array of ring magnets, and wherein the array of tubes is suspended above the array of ring magnets such that the bottom ends of the tubes are not resting within the hollow spaces of the ring magnets at different depths.

96. The method of claim 95, wherein the array of tubes is suspended above the array of ring magnets such that the tube holder plate is leveled with respect to the array of ring magnets.

97. The method of claim 93, wherein the array of magnets are held by a magnet holder plate, and wherein the raised frame comprises a plurality of feet, wherein each foot fits into a corresponding hole on the magnet holder plate such that the raised frame is mounted on the magnet holder plate.

98. The method of claim 97, wherein the raised frame is mounted on the magnet holder plate such that the raised frame is raised above the magnet holder plate.

99. The method of claim 93, wherein the raised frame comprises a plurality of collars, wherein each of the collars constrains a x location and a y location of the tube holder plate.

100. The method of claim 99, wherein each of the collars constrains the x location and the y location of the tube holder plate by having a tube inserted into the collar.
